(19) United States
(12) Patent Application Publication
(10) Pub. No.: US 2012/0154915 A1
(43) Pub. Date: Jun. 21, 2012

(54) VARIABLE WAVELENGTH INTERFERENCE FILTER, OPTICAL FILTER DEVICE, OPTICAL MODULE, AND ELECTRONIC APPARATUS

(75) Inventor: Nozomu HIROKUBO, Fujimi-machi (JP)

(73) Assignee: SEIKO EPSON CORPORATION, Tokyo (JP)

(21) Appl. No.: 13/331,568

(22) Filed: Dec. 20, 2011

(30) Foreign Application Priority Data
Dec. 21, 2010 (JP) 2010-284574
Oct. 13, 2011 (JP) 2011-225892

(51) Int. Cl. G02B 5/28

(52) U.S. Cl. 359/578

(57) ABSTRACT

A variable wavelength interference filter includes an electrostatic actuator that includes a fixed electrode and a movable electrode. The fixed electrode includes a plurality of fixed partial electrodes, the movable electrode includes a plurality of movable partial electrodes, and each partial actuator is configured by the fixed partial electrode and the movable partial electrode that face each other. The partial actuators have an equal area, have centers of gravity thereof arranged at equal angular intervals on a virtual circle having a center point of the movable portion as its center, and are electrically connected in series between partial electrodes for voltage application.

### BACKGROUND

1. Technical Field

The present invention relates to a variable wavelength interference filter, an optical filter device, an optical module, and an electronic apparatus.

2. Related Art

Generally, variable wavelength interference filters (optical filter elements) that extract light of a specific wavelength from light of a plurality of wavelengths are known (for example, see JP-A-2009-251105).

The variable wavelength interference filter (optical filter device) disclosed in JP-A-2009-251105 includes a first substrate that includes a movable portion (first portion) and a diaphragm (second portion) supporting the movable portion and a second substrate that faces the first substrate. In addition, a movable mirror is formed on the movable portion of the first substrate, and a fixed mirror is formed on a face of the second substrate that faces the movable portion. In the first substrate and the second substrate, ring shaped electrodes are disposed so as to configure an electrostatic actuator. In such a variable wavelength interference filter, by applying a voltage between the electrodes, the diaphragm is bent in accordance with an electrostatic attractive force so as to change a gap between the movable mirror and the fixed mirror, whereby light of a desired wavelength can be extracted.

In addition, a variable wavelength interference filter is known in which a plurality of partial actuators is disposed in an electrostatic actuator, and each one of the plurality of partial actuators can be controlled (for example, JP-A-2007-086517).

The variable wavelength interference filter disclosed in JP-A-2007-086517 includes a first substrate having a conductive movable portion and a second substrate, and reflective films are disposed on the movable portion of the first substrate and at a position of the second substrate that faces the movable portion. In addition, at positions of the second substrate that face the movable portion, two arc shaped driving electrodes are disposed. In such a variable wavelength interference filter, by applying different voltages between the two driving electrodes, different electrostatic attractive forces can be created between each driving electrode and the movable portion.

In the variable wavelength interference filter disclosed in JP-A-2009-251105, in a case where an inter-electrode gap between an electrode disposed on the first substrate and an electrode disposed on the second substrate is uniform, when a voltage is applied between the electrodes, the diaphragm is uniformly bent. Accordingly, the movable portion moves toward the second substrate side while maintaining its posture. However, in a case where there is a slight tilt in the diaphragm, and the inter-electrode gap is not uniform, the smaller the inter-electrode gap becomes, the stronger an electrostatic attractive force becomes, and the tilt in the diaphragm increases. In other words, in the initial state, although the tilt in the diaphragm is within an allowed tolerance for which the spectral accuracy is not affected, in a state in which a voltage is applied between the electrodes, the tilt in the diaphragm increases, whereby there is a case where the spectral accuracy deteriorates.

On the other hand, in JP-A-2007-086517, the driving electrode configuring the electrostatic actuator is divided into two or more electrodes. Accordingly, by controlling the voltages to be applied to the driving electrodes, even in a case where the tilt in the diaphragm increases, such a tilt can be corrected. However, in such a case, it is necessary to determine the tilted state of the diaphragm and to apply voltages corresponding thereto to each driving electrode. Therefore, a sensor or the like that is used for measuring the tilted state of the diaphragm or the inter-electrode gap needs to be arranged, and accordingly, there is the problem of a complicated configuration. In addition, since it is necessary to calculate the driving voltage to be applied to each driving electrode based on the tilted state of the diaphragm or the inter-electrode gap that has been measured, there is also a problem in that the process of controlling the driving of the electrostatic actuator is complicated.

### SUMMARY

An advantage of some aspects of the invention is that it provides a variable wavelength interference filter, an optical filter device, an optical module, and an electronic apparatus capable of suppressing a decrease in resolving power by employing a simple configuration even in a case where a gap dimension between reflective films changes.

An aspect of the invention is directed to a variable wavelength interference filter including: a first substrate; a second substrate facing the first substrate; a first reflective film that is disposed on the first substrate; a movable area that is disposed in the second substrate and can advance or retreat with respect to the first substrate; a second reflective film that is disposed on the movable area of the second substrate and faces the first reflective film across a gap; and an electrostatic actuator that includes a first electrode disposed on the first substrate and a second electrode disposed on the second substrate and facing the first electrode and advances or retreats (moves) the movable area with respect to the first substrate in accordance with voltage application. The first electrode includes a plurality of first partial electrodes, and the second electrode includes a plurality of second partial electrodes. Each one of the second partial electrodes is disposed in correspondence with any one of the plurality of first partial electrodes, and, in a plan view of the first substrate and the second substrate as viewed in a substrate thickness direction, at least a part of each second partial electrode overlaps the first partial electrode corresponding thereto. The electrostatic actuator includes a plurality of partial actuators that is configured by an area in which the first partial electrode and the second partial electrode corresponding to the first partial electrode overlap each other in the plan view, and partial electrodes for voltage application are configured by any two of the first partial electrodes and the second partial electrodes. Each of the plurality of partial actuators has an equal area in the plan view, and centers of gravity of the partial actuators are arranged at equal angular intervals on a virtual circle that has a center of gravity of the movable area as its center, and, in the electrostatic actuator, the plurality of the partial actuators is electrically connected to each other in series between the partial electrodes for voltage application.

Here, to electrically connect the plurality of partial actuators in series represents a configuration in which a connection between the first partial electrodes and a connection between the second partial electrodes are alternately repeated for the connection. For example, in a case where four partial actuators including the first to fourth partial actuators are electrically connected in series in the mentioned order, the first partial electrode of the first partial actuator and the first partial electrode of the second actuator are connected, the second partial electrode of the second partial actuator and the second partial electrode of the third partial actuator are connected, and the first partial electrode of the third partial actuator and the first partial electrode of the fourth partial actuator are connected.

Generally, the electrostatic attractive force F generated by an electrostatic actuator changes based on the amount of electric charge that is maintained by the electrostatic actuator and the area of the electrode. In addition, the amount of electric charge increases in accordance with an increase in the area of the electrode and increases in accordance with a decrease in the distance between the electrodes.

In contrast to this, according to the above-described variable wavelength interference filter, since the partial actuators are electrically connected in series, when a voltage V is applied between two partial electrodes for voltage application, a divided voltage corresponding to the capacitive reactance thereof is applied thereto, and the amounts of electric charge maintained in the partial actuators are the same. In addition, since the partial actuators have the same area in the plan view, the electrostatic attractive forces acting on the partial actuators have the same magnitude due to the same area of the electrode and the same amount of maintained electric charge.

Therefore, according to the above-described variable wavelength interference filter, even in a case where there is a difference in the gaps between the partial electrodes of the partial actuators due to a tilt in the first substrate or the second substrate, the electrostatic attractive forces having the same magnitude can be acted on the partial actuators. Accordingly, a disadvantage can be prevented in which a high electrostatic attractive force is acted on a part of the first substrate or the second substrate so as not to be able to maintain the parallel relationship between the first and second reflective films when a gap between the first reflective film and the second reflective film is changed by displacing the movable area of the second substrate to the first substrate side, whereby a decrease in the resolving power can be suppressed.

In addition, according to the above-described variable wavelength interference filter, by only applying a driving voltage between the two partial electrodes for voltage application, as described above, the electrostatic attractive force acting on the partial actuators can be made uniform, whereby a decrease in the resolving power can be suppressed. Accordingly, a complicated circuit used for controlling a voltage to be applied to each partial actuator is not necessary, and an individual voltage control process for each partial actuator does not need to be performed, whereby the electrostatic actuator can be controlled in an easy manner.

In the above-described variable wavelength interference filter, it is preferable that, in the plan view, an outer peripheral edge of one of the first partial electrode and the second partial electrode that configure the partial actuator is located on an inner side of an outer peripheral edge of the other. In other words, in the plan view, one of the first partial electrode and the second partial electrode is formed in a size larger than the other.

In such a case, the areas of the partial actuators can be aligned to be the same with high accuracy. For example, in a case where the first partial electrode and the second partial electrode are formed in the same shape, and the partial actuators are formed with the outer peripheral edges thereof coinciding with each other in the plan view, the alignment adjustment needs to be performed such that the outer peripheral edge of the first partial electrode and the outer peripheral edge of the second partial electrode coincide with each other, and an alignment adjusting process having high accuracy is necessary.

In contrast to this, in the above-described variable wavelength interference filter, since the peripheral edge of one of the first partial electrode and the second partial electrode is configured to be located on the inner side of the outer periphery of the other, the alignment adjustment may be performed such that the outer peripheral edge of one having a smaller size is located on the inner side of the peripheral edge of the other, and accordingly, the areas of the partial actuators in the plan view can be aligned in an easy manner.

In the above-described variable wavelength interference filter, it is preferable that the plurality of first partial electrodes has the same shape in the plan view, and the plurality of second partial electrodes has the same shape in the plan view.

In such a case, since the first partial electrodes have the same shape, and the second partial electrodes have the same shape, the positions of the first partial electrode and the second partial electrode can be adjusted (alignment adjustment) in an easier manner. Therefore, the manufacturing efficiency can be improved further.

In the above-described variable wavelength interference filter, it is preferable that the two partial electrodes for voltage application are arranged so as to be adjacent to each other on the virtual circle, and, in the electrostatic actuator, the partial actuators arranged along a circumferential direction of the virtual circle are electrically connected in series sequentially between the two partial electrodes for voltage application.

In such a case, the partial actuators are connected in series in the order of the alignment in the circumferential direction of the virtual circle. In such a configuration, a connection electrode portion that connects the partial actuators can be formed to be shortened, whereby the resistance can be decreased.

In the above-described variable wavelength interference filter, it is preferable that a plurality of the electrostatic actuators is disposed, and the electrostatic actuators are electrically connected to each other in parallel.

In such a case, as described above, a plurality of the electrostatic actuators in which the partial actuators are arranged at equal angular intervals is disposed. As described above, since a divided voltage is applied to each partial actuator, in a case where the number of the partial actuators configuring one electrostatic actuator is increased, the value of the divided voltage applied to each partial actuator decreases. In such a case, the electrostatic attractive forces acting on the partial actuators decrease, and, in order to acquire a desired electrostatic attractive force, it is necessary to increase the driving voltage. In contrast to this, in the above-described variable wavelength interference filter, by connecting the above-described electrostatic actuators in parallel, a desired electrostatic attractive force can be acquired through a low driving voltage.

For example, in a case where a variable wavelength interference filter in which two electrostatic actuators each configured by two partial actuators are connected in parallel and a variable wavelength interference filter in which one electrostatic actuator configured by four partial actuators is arranged are compared, in the former variable wavelength interference filter, the same electrostatic attractive force as that of the latter variable wavelength interference filter can be acquired by using a driving voltage that is approximately half of that of the latter variable wavelength interference filter.

Another aspect of the invention is directed to an optical filter device including: a variable wavelength interference filter that includes: a first substrate; a second substrate facing the first substrate; a first reflective film that is disposed on the first substrate; a movable area that is disposed in the second substrate and can advance or retreat with respect to the first substrate; a second reflective film that is disposed on the movable area of the second substrate and faces the first reflective film across a gap; and an electrostatic actuator that includes a first electrode disposed on the first substrate and a second electrode disposed on the second substrate and facing the first electrode and advances or retreats (moves) the movable area with respect to the first substrate in accordance with voltage application; and a casing that houses the variable wavelength interference filter. The first electrode includes a plurality of first partial electrodes, and the second electrode includes a plurality of second partial electrodes. Each one of the second partial electrodes is disposed in correspondence with any one of the plurality of first partial electrodes, and, in a plan view of the first substrate and the second substrate as viewed in a substrate thickness direction, at least a part of each second partial electrode overlaps the first partial electrode corresponding thereto. The electrostatic actuator includes a plurality of partial actuators that is configured by an area in which the first partial electrode and the second partial electrode corresponding to the first partial electrode overlap each other in the plan view, and partial electrodes for voltage application are configured by any two of the first partial electrodes and the second partial electrodes. Each of the plurality of partial actuators has an equal area in the plan view, and centers of gravity of the partial actuators are arranged at equal angular intervals on a virtual circle that has a center of gravity of the movable area as its center, and, in the electrostatic actuator, the plurality of partial actuators are electrically connected to each other in series between the partial electrodes for voltage application.

According to the above-described optical filter device, since the variable wavelength interference filter as described above is housed inside the casing, the variable wavelength interference filter can be protected from an external shock. In addition, since the penetration of charged particles from the outside can be suppressed by the casing, the first partial electrodes and the second partial electrodes are prevented from being charged by the charged particles. Accordingly, a problem of breaking of the balance between the electrostatic attractive forces, which is caused by a Coulomb force due to charging, can be avoided, whereby the parallelism between the first reflective film and the second reflective film can be maintained more reliably.

Still another aspect of the invention is directed to an optical module including: a first substrate; a second substrate facing the first substrate; a first reflective film that is disposed on the first substrate; a movable area that is disposed in the second substrate and can advance or retreat with respect to the first substrate; a second reflective film that is disposed on the movable area of the second substrate and faces the first reflective film across a gap; an electrostatic actuator that includes a first electrode disposed on the first substrate and a second electrode disposed on the second substrate and facing the first electrode and advances or retreats (moves) the movable area with respect to the first substrate in accordance with voltage application; and a detection unit that detects light extracted by the variable wavelength interference filter. The first electrode includes a plurality of first partial electrodes, the second electrode includes a plurality of second partial electrodes. Each one of the second partial electrodes is disposed in correspondence with any one of the plurality of first partial electrodes, and, in a plan view of the first substrate and the second substrate as viewed in a substrate thickness direction, at least a part of each second partial electrode overlaps the first partial electrode corresponding thereto. The electrostatic actuator includes a plurality of partial actuators that is configured by an area in which the first partial electrode and the second partial electrode corresponding to the first partial electrode overlap each other in the plan view, and partial electrodes for voltage application are configured by any two of the first partial electrodes and the second partial electrodes. Each of the plurality of partial actuators has an equal area in the plan view, and centers of gravity of the partial actuators are arranged at equal angular intervals on a virtual circle that has a center of gravity of the movable area as its center, and, in the electrostatic actuator, the plurality of partial actuators are electrically connected to each other in series between the partial electrodes for voltage application.

The above-described optical module employs a configuration that is the same as that of the above-described variable wavelength interference filter. Accordingly, even in a case where a gap between the first reflective film and the second reflective film is changed, the electrostatic attractive forces having the same magnitude can be acted on the partial actuators, whereby a decrease in the resolving power can be suppressed. Therefore, by detecting light extracted with high resolving power as above by using the detecting unit, a detection result can be acquired with high accuracy.

Yet another aspect of the invention is directed to an electronic apparatus including: a first substrate; a second substrate facing the first substrate; a first reflective film that is disposed on the first substrate; a movable area that is disposed in the second substrate and can advance or retreat with respect to the first substrate; a second reflective film that is disposed on the movable area of the second substrate and faces the first reflective film across a gap; and an electrostatic actuator that includes a first electrode disposed on the first substrate and a second electrode disposed on the second substrate and facing the first electrode and advances or retreats the movable area with respect to the first substrate in accordance with voltage application. The first electrode includes a plurality of first partial electrodes, and the second electrode includes a plurality of second partial electrodes. Each one of the second partial electrodes is disposed in correspondence with any one of the plurality of first partial electrodes, and, in a plan view of the first substrate and the second substrate as viewed in a substrate thickness direction, at least a part of each second partial electrode overlaps the first partial electrode corresponding thereto. The electrostatic actuator includes a plurality of partial actuators that is configured by an area in which the first partial electrode and the second partial electrode corresponding to the first partial electrode overlap each other in the plan view, and partial electrodes for voltage application are configured by any two of the first partial electrodes and the second partial electrodes. Each of the plurality of partial actuators has an equal area in the plan view, and centers of gravity of the partial actuators are arranged at equal angular intervals on a virtual circle that has a center of gravity of the movable area as its center, and, in the electrostatic actuator, the plurality of partial actuators are electrically connected to each other in series between the partial electrodes for voltage application.

Here, as examples of the electronic apparatus, there are a light measuring apparatus that analyzes the chromaticity, the brightness, or the like of measurement target light based on light extracted by the first reflective film and the second reflective film, a gas detecting apparatus that tests the kind of gas by detecting the absorbed wavelength of the gas, an optical communication apparatus that acquires data included in light of a wavelength from received light, and the like.

The above-described electronic apparatus employs a configuration that is the same as that of the above-described variable wavelength interference filter. Accordingly, even in a case where a gap dimension between the first reflective film and the second reflective film is changed, a uniform electrostatic attractive force can be acted on the partial actuators, whereby desired light can be extracted with high resolving power. Therefore, the electronic apparatus can perform various high-accuracy processes based on the light extracted with high resolving power.

### BRIEF DESCRIPTION OF THE DRAWINGS

The invention will be described with reference to the accompanying drawings, wherein like numbers reference like elements.

FIG. 1 is a diagram illustrating a schematic configuration of a colorimetric apparatus (electronic apparatus) according to a first embodiment of the invention.

FIG. 2 is a plan view showing a schematic configuration of a variable wavelength interference filter according to the first embodiment.

FIG. 3 is a cross-sectional view of the variable wavelength interference filter taken along line III-III shown in FIG. 2.

FIG. 4 is a plan view of a fixed substrate of the variable wavelength interference filter according to the first embodiment, as viewed from a movable substrate side.

FIG. 5 is a plan view of the movable substrate of the variable wavelength interference filter according to the first embodiment, as viewed from the fixed substrate side.

FIG. 6 is a wiring diagram of an electrostatic actuator according to the first embodiment.

FIG. 7 is a plan view showing a schematic configuration of a variable wavelength interference filter according to a second embodiment.

FIG. 8 is a plan view of a fixed substrate of the variable wavelength interference filter according to the second embodiment, as viewed from a movable substrate side.

FIG. 9 is a plan view of the movable substrate of the variable wavelength interference filter according to the second embodiment, as viewed from the fixed substrate side.

FIG. 10 is a wiring diagram of the variable wavelength interference filter according to the second embodiment.

FIG. 11 is a cross-sectional view showing a schematic configuration of an optical filter device according to a third embodiment.

FIG. 12 is a plan view showing a schematic configuration of a variable wavelength interference filter according to a modified example of the invention.

FIG. 13 is a wiring diagram of a variable wavelength interference filter according to another modified example.

FIG. 14 is a wiring diagram of the variable wavelength interference filter according to yet another modified example.

FIG. 15 is a schematic diagram showing a gas detecting apparatus that includes a variable wavelength interference filter according to an embodiment of the invention.

FIG. 16 is a block diagram showing the configuration of a control system of the gas detecting apparatus shown in FIG. 15.

FIG. 17 is a diagram showing a schematic configuration of a food analyzing apparatus that includes a variable wavelength interference filter according to an embodiment of the invention.

FIG. 18 is a schematic diagram showing a schematic configuration of a spectral camera that includes a variable wavelength interference filter according to an embodiment of the invention.

### DESCRIPTION OF EXEMPLARY EMBODIMENTS

### First Embodiment

Hereinafter, a first embodiment of the invention will be described with reference to the accompanying drawings.

### Overall Configuration of Colorimetric Apparatus

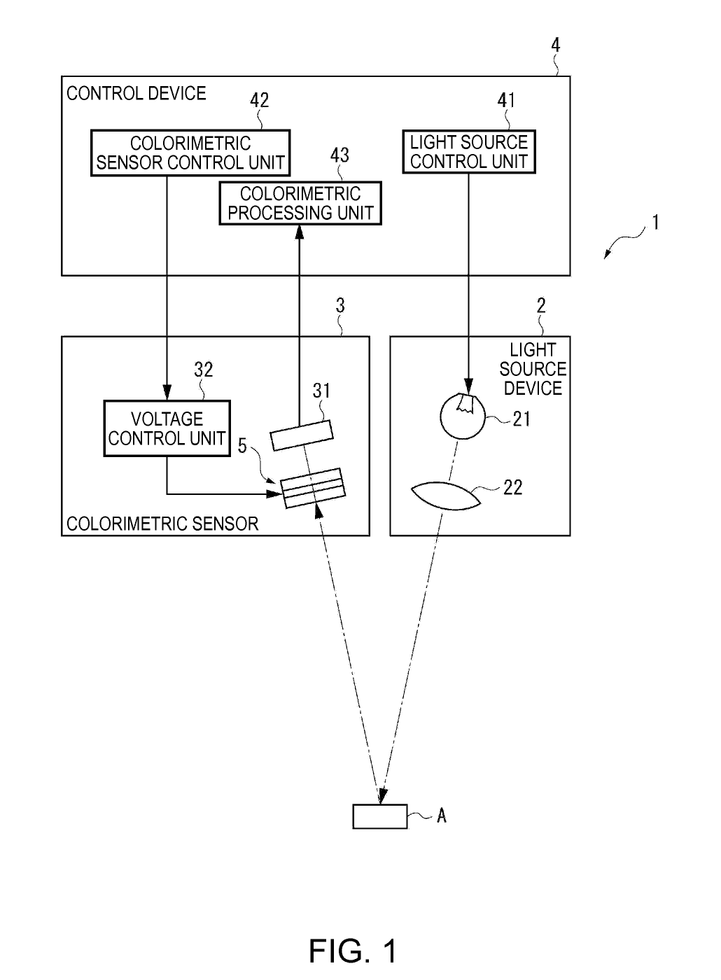

FIG. 1 is a diagram illustrating a schematic configuration of a colorimetric apparatus (electronic apparatus) according to an embodiment of the invention.

The colorimetric apparatus 1 is an electronic apparatus according to an embodiment of the invention and, as shown in FIG. 1, includes a light source device 2 that emits light onto a measurement target A, a colorimetric sensor 3 as an optical module according to an embodiment of the invention, and a control device 4 that controls the overall operation of the colorimetric apparatus 1. The colorimetric apparatus 1 is an apparatus that reflects light emitted from the light source device 2 on the measurement target A, receives reflected measurement target light by using the colorimetric sensor 3, and analyzes and measures the chromaticity of the measurement target light, that is, the color of the measurement target A based on a detection signal output from the colorimetric sensor 3.

### Configuration of Light Source Device

The light source device 2 includes a light source 21 and a plurality of lenses 22 (only one lens is shown in FIG. 1) and emits white light onto the measurement target A. A collimator lens may be included in the plurality of lenses 22. In such a case, the light source device 2 makes the white light emitted from the light source 21 be parallel light by using the collimator lens and emits the parallel light from a projection lens not shown in the figure toward the measurement target A.

In this embodiment, although the colorimetric apparatus 1 including the light source device 2 is illustrated as an example, for example, in a case where the measurement target A is a light emitting member such as a liquid crystal panel, a configuration may be employed in which the light source device 2 is not disposed.

### Configuration of Colorimetric Sensor

The colorimetric sensor 3 configures an optical module according to an embodiment of the invention. As shown in FIG. 1, the colorimetric sensor 3 includes: a variable wavelength interference filter 5; a detection unit 31 that receives and detects light transmitted through the variable wavelength interference filter 5; and a voltage control unit 32 that applies a driving voltage to the variable wavelength interference filter 5. In addition, the colorimetric sensor 3 includes an incidence optical lens, which is not shown in the figure, guiding the reflection light (measurement target light) reflected by the measurement target A to the inside thereof at the position facing the variable wavelength interference filter 5. In addition, in the colorimetric sensor 3, light of a predetermined wavelength is spectrally dispersed out of the measurement target light incident from the incidence optical lens using the variable wavelength interference filter 5, and the spectrally dispersed light is received by the detection unit 31.

The detection unit 31 is configured by a plurality of photoelectric conversion elements and generates an electric signal corresponding to the amount of received light. In addition, the detection unit 31 is connected to the control device 4 and outputs the generated electric signal to the control device 4 as a light reception signal.

### Configuration of Variable Wavelength Interference Filter

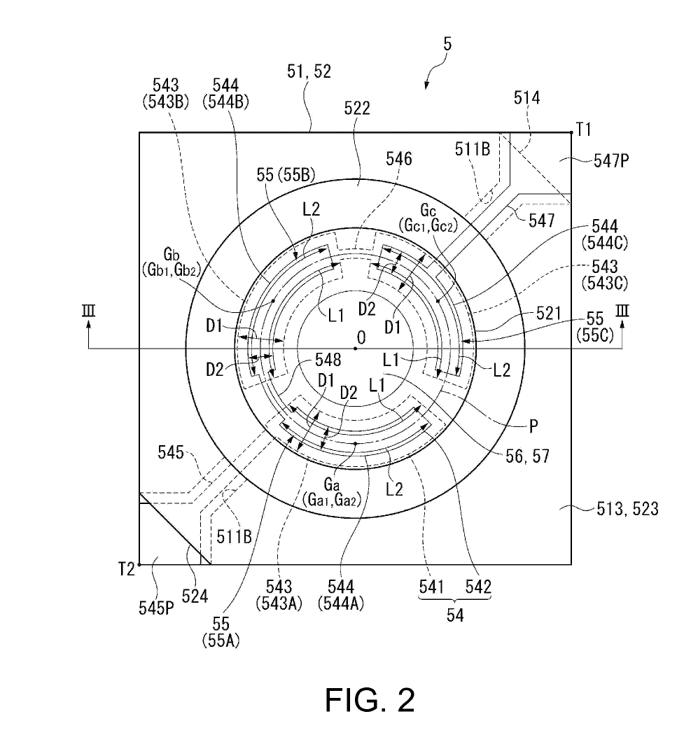

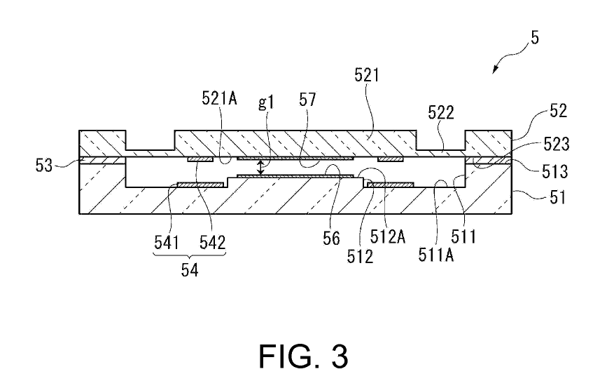

FIG. 2 is a plan view showing a schematic configuration of the variable wavelength interference filter 5. FIG. 3 is a cross-sectional view of the variable wavelength interference filter 5 taken along line III-III shown in FIG. 2.

The variable wavelength interference filter 5, as shown in FIG. 2, is an optical member, for example, having a square plate shape. As shown in FIG. 3, the variable wavelength interference filter 5 includes a fixed substrate 51 as a first substrate according to an embodiment of the invention and a movable substrate 52 as a second substrate according to an embodiment of the invention. Each one of the two substrates 51 and 52, for example, may be formed from various kinds of glass such as soda glass, crystalline glass, silica glass, lead glass, potassium glass, borosilicate glass, and alkali-free glass, a crystal, and the like. In addition, the fixed substrate 51 and the movable substrate 52 are integrally formed by bonding a first bonding portion 513 of the fixed substrate 51 and a second bonding portion 523 of the movable substrate together by using a bonding film 53 that is, for example, configured by a plasma polymerized film having siloxane as its main component, or the like.

On the fixed substrate 51, a fixed reflective film 56 that configures a first reflective film according to an embodiment of the invention is disposed, and, on the movable substrate 52, a movable reflective film 57 that configures a second reflective film according to an embodiment of the invention is disposed. Here, the fixed reflective film 56 is fixed to a face of the fixed substrate 51 that faces the movable substrate 52, and the movable reflective film 57 is fixed to a face of the movable substrate 52 that faces the fixed substrate 51. In addition, the fixed reflective film 56 and the movable reflective film 57 are arranged so as to face each other through a predetermined inter-reflective film gap g1.

Furthermore, an electrostatic actuator 54 used for adjusting the dimension of the gap between the fixed reflective film 56 and the movable reflective film 57 is disposed between the fixed substrate 51 and the movable substrate 52. The electrostatic actuator 54 includes a fixed electrode 541 as a first electrode, which is disposed on the fixed substrate 51 side, according to an embodiment of the invention and a movable electrode 542 as a second electrode, which is disposed on the movable substrate 52 side, according to an embodiment of the invention. Here, the electrodes 541 and 542 may be configured so as to be directly disposed on the substrate surfaces of the fixed substrate 51 and the movable substrate 52 or may be configured so as to be disposed through other film members.

In addition, in the plan view of the variable wavelength interference filter 5, as shown in FIG. 2, as viewed from the substrate thickness direction of the fixed substrate 51 (the movable substrate 52), the planar center point O of the fixed substrate 51 and the movable substrate 52 coincides with the center point of the fixed reflective film 56 and the movable reflective film 57 and coincides with the center point of a movable portion 521 to be described later.

In the description presented below, a plan view as viewed from the substrate thickness direction of the fixed substrate 51 or the movable substrate 52, that is, a plan view of the variable wavelength interference filter 5 as viewed from the stacking direction of the fixed substrate 51, the bonding film 53, and the movable substrate 52 will be described as a filter plan view.

### Configuration of Fixed Substrate

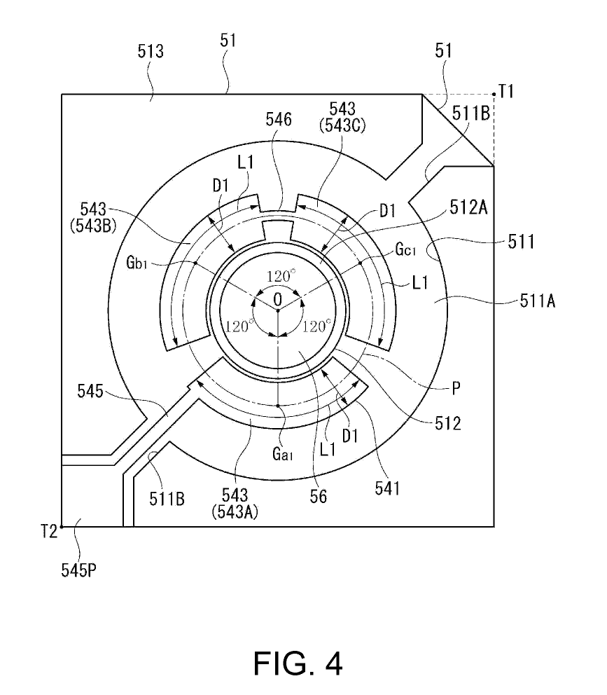

FIG. 4 is a plan view of the fixed substrate 51 of the variable wavelength interference filter 5 according to the first embodiment, as viewed from the movable substrate 52 side.

The fixed substrate 51 is formed by processing a glass member, for example, formed to have a thickness of 500 μm. More specifically, as shown in FIG. 3, an electrode arrangement groove 511 and a reflective film installing portion 512 are formed on the fixed substrate 51 through etching. Since the fixed substrate 51 is formed so as to have a thickness larger than the movable substrate 52, there is substantially no substantial electrostatic attractive force generated by applying a voltage between the fixed electrode 541 and the movable electrode 542 or no bending of the fixed substrate 51 that is caused by the internal stress of the fixed electrode 541.

In addition, since a notch 514 is formed at the apex T1 (see FIG. 2) of the fixed substrate 51, a movable electrode pad 547P to be described later is exposed to the fixed substrate 51 side of the variable wavelength interference filter 5.

The electrode arrangement groove 511, as shown in FIG. 4, is formed in a circular shape having the planar center point of the fixed substrate 51 as its center in the filter plan view. The reflective film installing portion 512, in the filter plan view, is formed so as to protrude from the center portion of the electrode arrangement groove 511 to the movable substrate 52 side. Here, the groove bottom face of the electrode arrangement groove 511 is an electrode installing face 511A on which the fixed electrode 541 is disposed. In addition, the protruded tip end face of the reflective film installing portion 512 is a reflective film installing face 512A.

In addition, in the fixed substrate 51, electrode extension grooves 511B that extend from the electrode arrangement groove 511 toward apexes T1 and T2 of the outer peripheral edge of the fixed substrate 51 are disposed.

In the electrode installing face 511A of the electrode arrangement groove 511, the fixed electrode 541 is formed.

This fixed electrode 541, as shown in FIG. 4, is configured by a plurality of fixed partial electrodes 543 (543A, 543B, and 543C) having arc shapes along the circumference of a virtual circle P having the planar center point O as its center. The fixed partial electrode 543 configures a first partial electrode according to an embodiment of the invention.

In this embodiment, in the filter plan view, the length dimension L1 of each fixed partial electrode 543 along the circumferential direction of the virtual circle P is formed to be the same, and the width dimension D1 thereof along the direction (the diameter direction of the virtual circle P) perpendicular to the tangent line of the virtual circle P is formed to be the same. In addition, the fixed partial electrodes 543A, 543B, and 543C are arranged such that the centers Gₐ₁, G_{b1}, and G_{c1}of gravity thereof are at equal angular intervals (intervals of 120 degrees) on the circumference of the virtual circle P. In addition, it is preferable that the thickness dimension of each fixed partial electrode 543 is set to be the same.

Here, out of the three fixed partial electrodes 543, the fixed partial electrode 543A includes a fixed electrode extending line 545. This fixed electrode extending line 545 extends from the outer peripheral edge of the fixed partial electrode 543A in the direction of the apex T2, and, in the tip end portion thereof, a fixed electrode pad 545P that is connected to the voltage control unit 32 is disposed.

In addition, the fixed partial electrode 543B and the fixed partial electrode 543C are connected to each other through a fixed electrode connecting line 546.

On the fixed partial electrode 543, an insulating film (not shown in the figure) that is used for preventing electric discharge between the fixed electrode 541 and the movable electrode 542 is stacked.

On the same axis as that of the electrode arrangement groove 511, the reflective film installing portion 512, as described above, is formed in a cylindrical shape having a diameter dimension smaller than the electrode arrangement groove 511. In this embodiment, as shown in FIG. 3, although an example is shown in which the reflective film installing face 512A of the reflective film installing portion 512 that faces the movable substrate 52 is formed to be closer to the movable substrate 52 than the electrode installing face 511A, the invention is not limited thereto. The height positions of the electrode installing face 511A and the reflective film installing face 512A are appropriately set based on the dimension of the inter-reflective film gap g1, a dimension between the fixed electrode 541 and the movable electrode 542, the thickness dimension of the fixed reflective film 56 or the movable reflective film 57, a wavelength region as a measurement target, and the like. Thus, for example, a configuration in which the electrode installing face 511A and the reflective film installing face 512A are formed on the same face or a configuration in which a reflective film fixing groove having a cylindrical concave groove shape is formed at the center portion of the electrode installing face 511A, and a reflective film fixing face is formed on the bottom face of the reflective film fixing groove, or the like may be employed.

In addition, the fixed reflective film 56 formed in a circular shape is fixed to the reflective film installing face 512A. As the fixed reflective film 56, for example, a metal film formed from Ag or the like, or an alloy film formed from an Ag alloy or the like may be used. In addition, a dielectric multi-layer film that includes, for example, a high refraction layer formed from TiO₂ and a low refraction layer formed from SiO₂ may be used. Furthermore, a reflective film acquired by stacking a metal film (or an alloy film) on a dielectric multi-layer film, a reflective film acquired by stacking a dielectric multi-layer film is stacked on a metal film (or an alloy film), a reflective film acquired by stacking a single-layer refractive layer (formed from TiO₂, SiO₂, or the like) and a metal film (or an alloy film) are stacked, or the like may be used.

Furthermore, a configuration may be employed in which an anti-reflection film (AR) is disposed at a position on a face of the fixed substrate 51, which is opposite to a face facing the movable substrate 52, that corresponds to the fixed reflective film 56. The anti-reflection film is formed by alternately stacking a low-refractive index film and a high-refractive index film and reduces the reflectivity of the surface of the fixed substrate 51 for visible light, thereby increasing the transmissivity.

In addition, out of faces of the fixed substrate 51 that face the movable substrate 52, a face in which the electrode arrangement groove 511, the reflective film installing portion 512, and the electrode extension groove 511B are not formed through etching configures the first bonding portion 513. This first bonding portion 513, as described above, is bonded to the second bonding portion 523 of the movable substrate 52 through the bonding film 53.

### Configuration of Movable Substrate

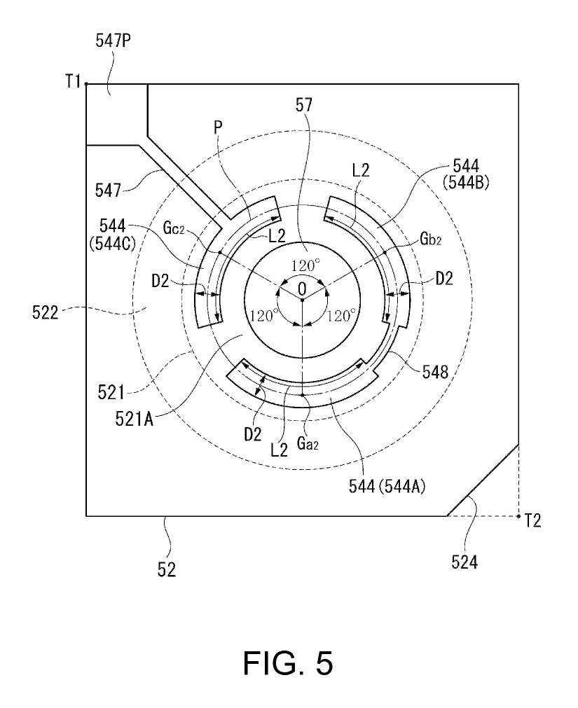

FIG. 5 is a plan view of the movable substrate 52 of the variable wavelength interference filter 5 according to the first embodiment, as viewed from the fixed substrate 51 side.

The movable substrate 52 is formed by processing a glass member, for example, formed to have a thickness of 200 μm through etching.

More specifically, the movable substrate 52, in the filter plan view as shown in FIGS. 2 and 5, includes a circle-shaped movable portion 521 that has the substrate center point (planar center point O) as its center and a holding portion 522 that has an axis that is the same as that of the movable portion 521 and holds the movable portion 521. Here, a movable area according to an embodiment of the invention is configured by the movable portion 521 and the holding portion 522 and the center of gravity of the movable area coincides with the planar center point O.

In addition, the movable substrate 52, as shown in FIGS. 2 and 5, includes a notch 524 at the position of the apex T2, and the fixed electrode pad 545P is exposed to the movable substrate 52 side of the variable wavelength interference filter 5.

The movable portion 521 has a thickness dimension larger than that of the holding portion 522, and, for example, is formed to have a thickness of 200 μm that is the same as that of the movable substrate 52 in this embodiment. In addition, the movable portion 521 includes a movable face 521A that is in parallel with the reflective film installing portion 512, and, in this movable face 521A, the movable reflective film 57 and the movable electrode 542 are disposed.

In addition, similarly to the fixed substrate 51, an anti-reflection film may be formed on a face of the movable portion 521 that is opposite to the fixed substrate 51. The anti-reflection film can be formed by alternately stacking a low-refractive index film and a high-refractive index film and reduces the reflectivity of the surface of the movable substrate 52 for visible light, thereby increasing the transmissivity.

The movable reflective film 57 is disposed at the center portion of the movable face 521A of the movable portion 521 so as to face the fixed reflective film 56 through the inter-reflective film gap g1. As this movable reflective film 57, a reflective film that has the same configuration as that of the above-described fixed reflective film 56 is used.

The movable electrode 542 is disposed so as to face the fixed electrode 541 and configures the electrostatic actuator 54 together with the fixed electrode 541.

This movable electrode 542, as shown in FIG. 5, is configured by a plurality of movable partial electrodes 544 (544A, 544B, and 544C) having arc shapes along the virtual circle P. The movable partial electrode 544 configures a second partial electrode according to an embodiment of the invention.

In this embodiment, in the filter plan view, the length dimension L2 of each movable partial electrode 544 along the direction of the circumference of the virtual circle P is formed to be the same dimension, and the length dimension L2 is smaller than the length dimension L1 of the fixed partial electrode 543. In addition, in the filter plan view, the width dimension D2 of each movable partial electrode 544 along the diameter direction of the virtual circle P is formed to be the same dimension, and the width dimension D2 is smaller than the width dimension D1 of the fixed partial electrode 543. Furthermore, it is preferable that the thickness dimension of each movable partial electrode 544 is formed to be the same thickness dimension.

In addition, in the filter plan view, the movable partial electrodes 544A, 544B, and 544C are arranged such that the centers of gravity Gₐ₂, G_{b2}, and G_{c2} thereof are at equal angular intervals (intervals of 120 degrees) on the circumference of the virtual circle P. The centers of gravity Gₐ₂ G_{b2}, and G_{c2} coincide with the centers of gravity Gₐ₁, G_{b1}, and G_{c1} of the fixed partial electrodes 543A, 543B, and 543C. In other words, in the filter plan view, the outer peripheral edge of each movable partial electrode 544 is disposed on the inner side of the outer peripheral edge of each fixed partial electrode 543. In other words, each movable partial electrode 544 is formed smaller than each fixed partial electrode 543.

A partial actuator 55 according to an embodiment of the invention is configured by an area in which the movable partial electrode 544 and the fixed partial electrode 543 overlap each other in the filter plan view.

In addition, out of the movable partial electrodes 544, the movable partial electrode 544C includes a movable electrode extending line 547. This movable electrode extending line 547 extends from the outer peripheral edge of the movable partial electrode 544C toward the apex T1, and, in the tip end portion thereof, a movable electrode pad 547P that is connected to the voltage control unit 32 is disposed.

Furthermore, the movable partial electrode 544A and the movable partial electrode 544B are connected to each other through a movable electrode connecting line 548.

The holding portion 522 is a diaphragm that surrounds the periphery of the movable portion 521, is, for example, formed to have a thickness dimension of 50 μm, and is formed so as to have a rigidity in the thickness direction smaller than that of the movable portion 521.

For this reason, the holding portion 522 is easily bent more than the movable portion 521 and can be bent toward the fixed substrate 51 side by a low electrostatic attractive force. In such a case, since the movable portion 521 has a thickness dimension larger than that of the holding portion 522 and a rigidity higher than that of the holding portion 522, even in a case where a bending force is applied to the movable substrate 52 by the electrostatic attractive force, the movable portion 521 hardly bends, and it is possible to prevent the bending of the movable reflective film 57 that is formed in the movable portion 521.

### Configuration of Electrostatic Actuator

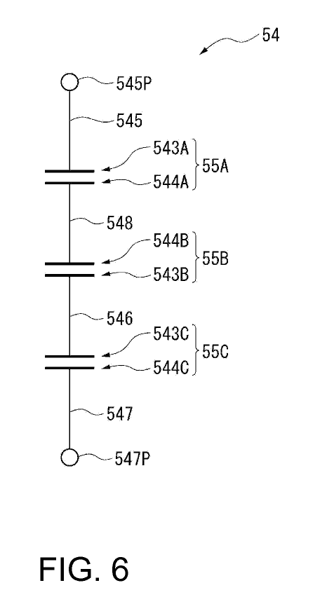

FIG. 6 is a wiring diagram of the electrostatic actuator 54 according to the first embodiment.

The electrostatic actuator 54, as shown in FIG. 2, in the filter plan view, includes a partial actuator 55A that is configured by an area in which the fixed partial electrode 543A and the movable partial electrode 544A overlap each other, a partial actuator 55B that is configured by an area in which the fixed partial electrode 543B and the movable partial electrode 544B overlap each other, and a partial actuator 55C that is configured by an area in which the fixed partial electrode 543C and the movable partial electrode 544C overlap each other.

Here, as described above, in the filter plan view, since the outer peripheral edge of the movable partial electrode 544 is located on the inner side of the outer peripheral edge of the fixed partial electrode 543 that faces the movable partial electrode 544, the area of the partial actuator 55 in the filter plan view is the same as the area of the movable partial electrode 544. In addition, in this embodiment, since the movable partial electrodes 544 are formed in the same shape, the areas of the partial actuators 55 in the filter plan view are the same. Furthermore, the centers of gravity Gₐ₂, G_{b2}, and G_{c2} of the movable partial electrodes 544 in the filter plan view coincide with centers of gravity Gₐ, G_{b}, and G_{c} of the partial actuators 55, and the movable partial electrodes 544 are configured so as to be arranged at equal angular intervals (intervals of 120 degrees) on the circumference of the virtual circle P.

In addition, as described above, the fixed electrode extending line 545 is formed in the fixed partial electrode 543A, the movable electrode extending line 547 is formed in the movable partial electrode 544C, and the fixed electrode extending line 545 and the movable electrode extending line 547 are connected to the voltage control unit 32. In other words, the fixed partial electrode 543A and the movable partial electrode 544C configure a partial electrode for voltage application according to an embodiment of the invention.

Furthermore, the partial actuators 55A and 55B are connected to each other through the movable electrode connecting line 548, and the partial actuators 55B and 55C are connected to each other through the fixed electrode connecting line 546. In other words, the partial actuators 55 (55A, 55B, and 55C) that configure the electrostatic actuator 54, as shown in FIG. 6, are electrically connected in series.

In the electrostatic actuator 54 having such a configuration, when a driving voltage V is applied between the fixed electrode pad 545P and the movable electrode pad 547P, divided voltages V₁, V₂, and V₃ corresponding to the capacitance reactance values thereof are applied to the partial actuators 55A, 55B, and 55C.

When the dimensions (gaps between partial electrodes) between the fixed partial electrodes 543 and the movable partial electrodes 544 of the partial actuators 55A, 55B, and 55C are d₁, d₂, and d₃, the area of each one of the partial actuators 55A, 55B, and 55C in the filter plan view is S, and the dielectric constant is ∈, the electrostatic capacitance values C₁, C₂, and C₃ of the partial actuators 55A, 55B, and 55C can be represented in the following Equations (1) to (3).

C₁=∈S/d₁ (1)

C₂=∈S/d₂ (2)

C₃=∈S/d₃ (3)

Here, since the partial actuators 55A, 55B, 55C are electrically connected in series, the amounts Q of electric charges maintained in the partial actuators 55A, 55B, and 55C are the same, and accordingly, the following Equation (4) is satisfied.

Q=C₁V₁=C₂V₂=C₃V₃ (4)

In addition, the electrostatic attractive forces F₁, F₂, and F₃ acting on the partial actuators 55A, 55B, and 55C are products E₁Q, E₂Q, and E₃Q of electric fields E₁, E₂, and E₃ applied between the fixed partial electrodes 543 and the movable partial electrodes 544 of the partial actuators 55A, 55B, and 55C and the amounts Q of electric charges maintained in the partial actuators 55A, 55B, and 55C.

Accordingly, the electrostatic attractive forces F₁, F₂, and F₃ can be represented in the following Equations (5) to (7) by substituting Equations (1) to (4) described above.

F₁=E₁Q=Q²/∈S (5)

F₂=E₂Q=Q²/∈S (6)

F₃=E₃Q=Q²/∈S (7)

In other words, as shown in Equations (5) to (7) described above, the electrostatic attractive forces E₁, F₂, and F₃ acting on the partial actuators 55A, 55B, and 55C have the same value regardless of the values of the inter-partial electrode gaps d₁, d₂, and d₃.

Accordingly, for example, in the initial gaps, even in a case where there are slight differences of levels, for example, not affecting the measurement accuracy in the values of the inter-partial electrode gaps d₁, d₂, and d₃, and a voltage is applied to the electrostatic actuators 54, the differences in the inter-partial electrode gaps d₁, d₂, and d₃ do not increase, and accordingly, the holding portion 522 can be uniformly bent.

### Configuration of Voltage Control Unit

The voltage control unit 32 controls the voltage to be applied to the electrostatic actuator 54 based on a control signal that is input from the control device 4.

### Configuration of Control Device

The control device 4 controls the overall operation of the colorimetric apparatus 1.

As the control device 4, for example, a general-purpose personal computer, a portable information terminal, a colorimetry-dedicated computer, or the like may be used.

As shown in FIG. 1, the control device 4 includes a light source control unit 41, a colorimetric sensor control unit 42, a colorimetric processing unit 43 configuring an analysis processing unit according to an embodiment of the invention, and the like.

The light source control unit 41 is connected to the light source device 2. In addition, the light source control unit 41 outputs a predetermined control signal to the light source device 2, for example, based on a setting input from a user and emits white light having a predetermined brightness level from the light source device 2.

The colorimetric sensor control unit 42 is connected to the colorimetric sensor 3. In addition, the colorimetric sensor control unit 42 sets a wavelength of the light to be received by the colorimetric sensor 3, for example, based on a setting input from a user and outputs a control signal for the purpose of detecting the amount of received light having the wavelength to the colorimetric sensor 3. As a result, the voltage control unit 32 of the colorimetric sensor 3 sets the voltage applied to the electrostatic actuator 54 based on the control signal such that only light having a wavelength desired by a user is transmitted.

The colorimetric processing unit 43 analyzes the chromaticity of the measurement target A based on the amount of the received light that is detected by the detection unit 31.

Operation and Advantages of this Embodiment

As described above, the variable wavelength interference filter 5 according to the above-described embodiment includes the electrostatic actuator 54 that generates an electrostatic attractive force used for advancing or retreating (attracting or repelling) the movable portion 521 toward or from the fixed substrate 51. The electrostatic actuator 54 includes the fixed electrode 541 that is configured by a plurality of the fixed partial electrodes 543 and the movable electrode 542 that is configured by a plurality of the movable partial electrodes 544. In addition, the partial actuators 55, each configured by an area in which the fixed partial electrode 543 and the movable partial electrode 544 overlap each other in the filter plan view, are configured. The partial actuators 55 have the same area in the filter plan view. In addition, the centers of gravity Gₐ, G_{b}, and G_{c} of the partial actuators 55 are arranged at equal angular intervals on the circumference of the virtual circle P having the planar center point O as its center and are electrically connected in series.

In such a configuration, when a driving voltage is applied to the electrostatic actuator 54, as represented in Equations (5) to (7) described above, electrostatic attractive forces having the same strength are applied to the partial actuators 55. In addition, as described above, since the partial actuators 55 are arranged at the equal angular intervals, the holding portion 522 receives a uniform electrostatic attractive force so as to be uniformly bent toward the fixed substrate 51 side by the partial actuators 55 arranged at the equal angular intervals, and the movable portion 521 can be moved toward the fixed substrate 51 side while maintaining the posture of the initial state (the initial alignment).

Accordingly, even in a case where the gap between the fixed reflective film 56 and the movable reflective film 57 is changed, the parallelism between the fixed reflective film 56 and the movable reflective film 57 can be maintained, whereby a decrease in resolving power can be suppressed.

In addition, in the colorimetric sensor 3 including the above-described variable wavelength interference filter 5, light that is spectrally dispersed with high resolving power can be detected by the detection unit 31, and accordingly, an accurate detection result of the light amount can be acquired. Furthermore, the colorimetric apparatus 1 measures the color of the measurement target A based on the amount of light detected by the colorimetric sensor 3, whereby a colorimetric process with high accuracy can be performed.

In addition, by only applying a driving voltage between the fixed partial electrodes 543A and the movable partial electrodes 544C as partial electrodes for voltage application, the electrostatic attractive forces in the partial actuators can be configured to have the same value in an easy manner. Accordingly, a complex control method in which a voltage to be applied to each partial actuator 55 is controlled or the like for controlling each partial actuator 55 is unnecessary, and accordingly, a control circuit used for controlling the partial actuators and the like are unnecessary. In other words, even in a case where the gap between the reflective films 56 and 57 is changed, a decrease in the resolving power can be suppressed by employing a simple configuration and a simple voltage control process.

Furthermore, the partial actuators 55A, 55B, and 55C of the electrostatic actuator 54 are electrically connected in series in the order of the arrangement along the direction of the periphery of the virtual circle P from the fixed partial electrode 543A as the partial electrode for voltage application located on one side to the movable partial electrode 544C as the partial electrode for voltage application located on the other side.

In such a configuration, the distance between the fixed electrode connecting line 546 and the movable electrode connecting line 548 can be shortened, whereby an increase in the resistance can be prevented. Particularly, the number of partial actuators configuring the electrostatic actuator 54 is four or more, and as the number of the partial actuators increases, the number of connection lines connecting the partial actuators is increased. In such a case, in a case where the partial actuators are electrically connected in series in an irregular order, although the configuration of the fixed electrode connecting line 546 and the movable electrode connecting line 548 becomes complicated so as to increase the resistance, the increase in the resistance can be effectively prevented by electrically connecting the partial actuators in series in the order of the arrangement along the direction of the periphery of the virtual circle P.

The variable wavelength interference filter 5 according to this embodiment is formed such that the length dimension L1 of each fixed partial electrode 543 is larger than the length dimension L2 of each movable partial electrode 544, and the width dimension D1 of each fixed partial electrode 543 is larger than the width dimension D2 of each movable partial electrode 544. In other words, in the filter plan view, the outer peripheral edge of the movable partial electrode 544 is located on the inner side of the outer peripheral edge of the fixed partial electrode that faces the movable partial electrode 544.

In such a configuration, the areas of the partial actuators 55 can be set to the same area with high accuracy.

In an embodiment of the invention, for example, the fixed partial electrodes 543 and the movable partial electrodes 544 may be formed in the same shape. Even in such a case, by performing alignment adjustment such that the outer peripheral edges thereof coincide with each other in the filter plan view, a variable wavelength interference filter according to an embodiment of the invention can be configured. However, in such a case, a case may be considered in which it is difficult to perform alignment adjustment so as to configure the outer peripheral edge of the fixed partial electrode 543 and the outer peripheral edge of the movable partial electrode 544 to coincide with each other in the filter plan view. In contrast to this, as in this embodiment, by configuring the size of the fixed partial electrode 543 to be larger than that of the movable partial electrode 544, alignment adjustment may be performed such that the movable partial electrode 544 is located on the inner side of the fixed partial electrode 543 in the filter plan view, whereby the partial actuators 55 having the same area can be formed in an easy manner. Therefore, the manufacturing efficiency can be improved.

In addition, in this embodiment, although the centers of gravity of the fixed partial electrodes 543 and the movable partial electrodes 544 are configured to coincide with each other, as described above, the position of the partial actuator is regulated by the movable partial electrode 544, and accordingly, the gravity center of the fixed partial electrode 543 and the center of gravity of the movable partial electrode 544 do not need to coincide with each other necessarily. In a case where the position of the partial actuator is regulated by each movable partial electrode 544, when the centers of gravity of the movable partial electrodes 544 are arranged at equal angular intervals on the circumference of the virtual circle P, the centers of gravity of the partial actuators 55 are arranged at equal angular intervals on the circumference of the virtual circle P as well.

Accordingly, as described above, in a configuration in which the outer peripheral edge of the movable partial electrode 544 is located on the inner side of the outer peripheral edge of the fixed partial electrode 543, by forming the shape and the position of the movable partial electrode 544 with high accuracy, even in a case where a manufacturing error or the like is included in the shape or the position of the fixed partial electrode 543, the position and the area of each partial actuator 55 can be accurately set.

In addition, since the size of the movable partial electrode 544 is formed to be smaller than that of the fixed partial electrode 543, the film stress caused by the movable partial electrode 544 decreases, whereby the bending caused by the film stress of the movable substrate 52 can be decreased.

The fixed partial electrodes 543 are formed in the same shape, and the movable partial electrodes 544 are formed in the same shape.

In such a configuration, the position adjustment of the fixed partial electrodes 543 and the movable partial electrodes 544 so as to form the partial actuators 55 can be easily performed, whereby the manufacturing efficiency can be improved further.

### Second Embodiment

Next, a second embodiment of the invention will be described with reference to the drawings.

In the variable wavelength interference filter 5 according to the above-described first embodiment, a configuration example is shown in which one electrostatic actuator 54 acquired by electrically connecting a plurality of the partial actuators 55 in series is disposed.

In contrast to this, in a variable wavelength interference filter 5A according to the second embodiment, a configuration is employed in which a plurality of electrostatic actuators (a first electrostatic actuator 54A and a second electrostatic actuator 54B) is disposed and is electrically connected in parallel. Hereinafter, the configuration of the variable wavelength interference filter 5A will be described in detail.

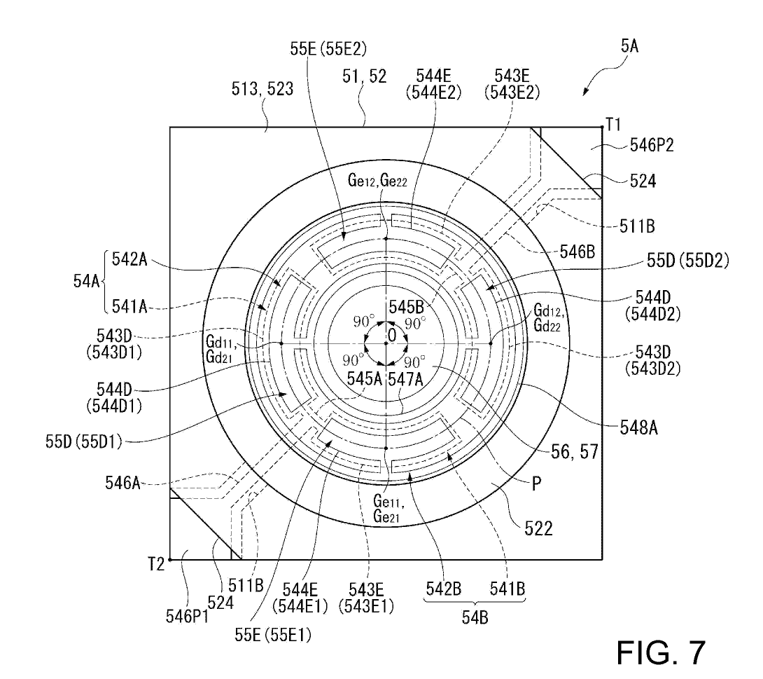

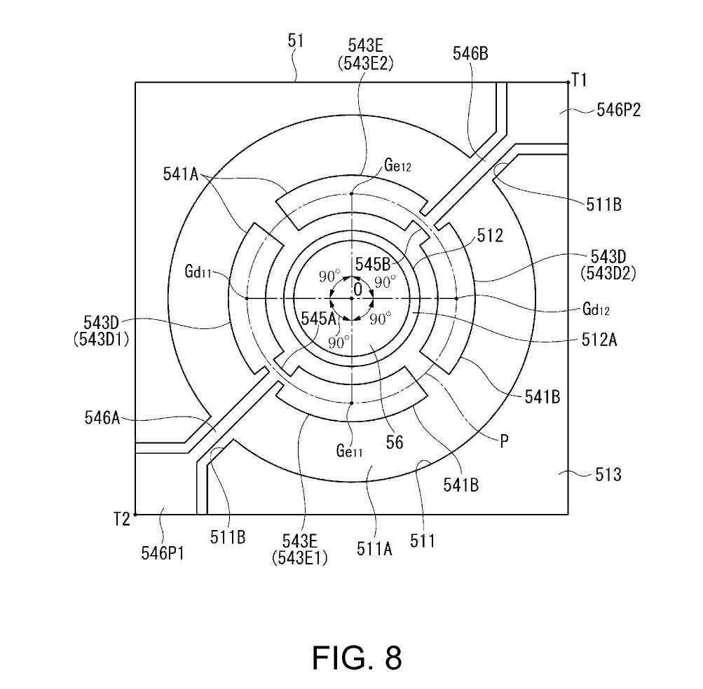

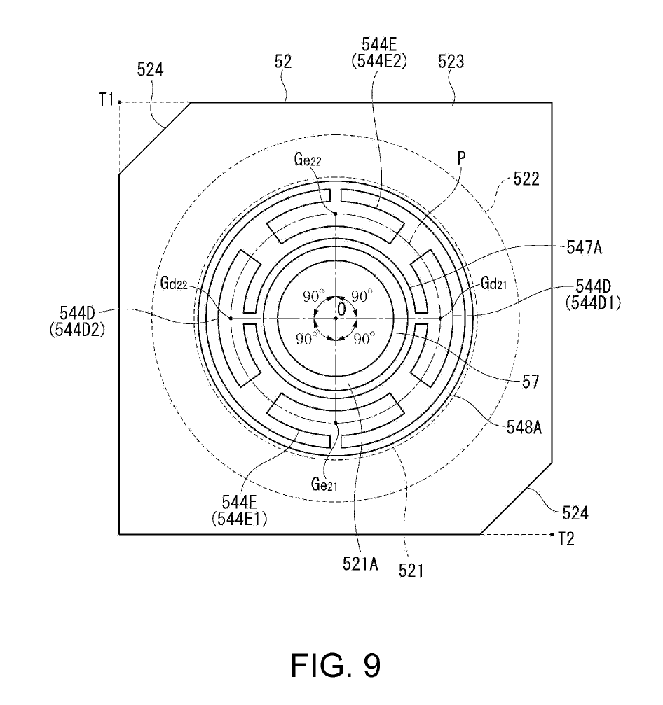

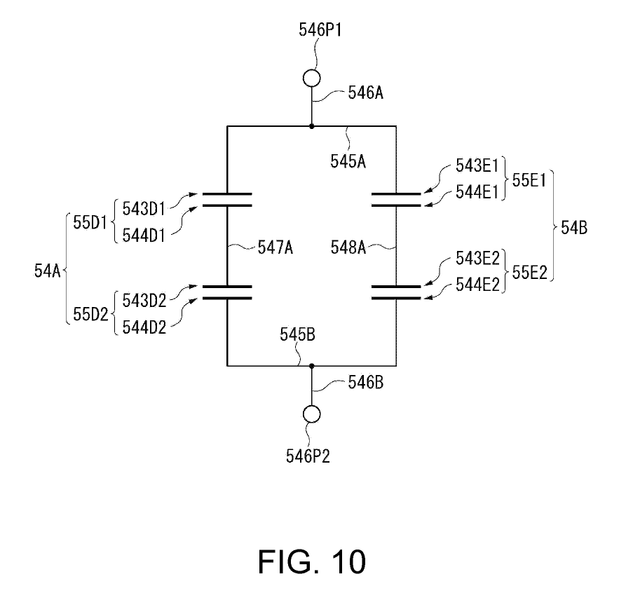

FIG. 7 is a plan view showing a schematic configuration of the variable wavelength interference filter 5A according to the second embodiment. FIG. 8 is a plan view of a fixed substrate 51 of the variable wavelength interference filter 5A, as viewed from a movable substrate 52 side. FIG. 9 is a plan view of the movable substrate 52 of the variable wavelength interference filter 5A, as viewed from the fixed substrate 51 side. FIG. 10 is a wiring diagram of the variable wavelength interference filter 5A. The same reference numerals are assigned to the same configurations as those of the first embodiment, and the description thereof will be omitted or simplified.

### Configuration of Fixed Substrate

In the fixed substrate 51 of the variable wavelength interference filter 5A, similarly to the first embodiment, an electrode arrangement groove 511 and a reflective film installing portion 512 are formed through etching. In addition, in the fixed substrate 51 of the second embodiment, the notch 514 is not formed.

In addition, in the groove bottom portion of the electrode arrangement groove 511 of the fixed substrate 51, a first fixed electrode 541A configuring the first electrostatic actuator 54A and a second fixed electrode 541B configuring the second electrostatic actuator 54B are formed.

The first fixed electrode 541A, as shown in FIG. 8, is configured by a plurality of (two in the second embodiment) first fixed partial electrodes 543D (543D1 and 543D2) having arc shapes extending along a virtual circle P. The first fixed partial electrode 543D configures a first partial electrode according to an embodiment of the invention in the first electrostatic actuator 54A.

The second fixed electrode 541B, as shown in FIG. 8, is configured by a plurality of (two in the second embodiment) second fixed partial electrodes 543E (543E1 and 543E2) having arc shapes extending along the virtual circle P. The second fixed partial electrode 543E configures a first partial electrode according to an embodiment of the invention in the second electrostatic actuator 54B.

The first fixed partial electrodes 543D have the same planar shape in the filter plan view and are formed to have the same thickness dimension. In addition, the first fixed partial electrodes 543D, in the filter plan view, are arranged along the circumference of the virtual circle P, and the centers of gravity G_{d11} and G_{d12} of each first fixed partial electrode 543D are arranged at equal angular intervals (intervals of 180 degrees) on the virtual circle P.

The second fixed partial electrodes 543E are formed so as to have the same planar shape and the same thickness dimension. In addition, the second fixed partial electrodes 543E, in the filter plan view, are arranged along the circumference of the virtual circle P, and the centers of gravity Gₑ₁₁ and Gₑ₁₂ of each second fixed partial electrode 543E are arranged at equal angular intervals (intervals of 180 degrees) on the virtual circle P.

It is preferable that the first fixed partial electrode 543D and the second fixed partial electrode 543E are formed so as to have the same planar shape in the filter plan view and have the same thickness dimension. In addition, it is preferable that the first fixed partial electrodes 543D and the second fixed partial electrode 543E are arranged at equal angular intervals (intervals of 90 degrees) along the circumferential direction of the virtual circle P.

The first fixed partial electrode 543D1 and the second fixed partial electrode 543E1 are connected to each other through a fixed electrode connecting line 545A. From this fixed electrode connecting line 545A, a fixed electrode extending line 546A is formed to extend toward the apex T2 (the lower left side in FIGS. 7 and 8). In the tip end portion of the fixed electrode extending line 546A, an electrode pad 546P1 that is connected to a voltage control unit 32 is disposed.

The first fixed partial electrode 543D2 and the second fixed partial electrode 543E2 are connected to each other through a fixed electrode connecting line 545B. From this fixed electrode connecting line 545B, a fixed electrode extending line 546B is formed to extend toward the apex T1 (the upper right side in FIGS. 7 and 8). In the tip end portion of the fixed electrode extending line 546B, an electrode pad 546P2 that is connected to the voltage control unit 32 is disposed.

On the first and second fixed partial electrodes 543D and 543E, an insulating film used for securing the insulating property is stacked.

Since the configurations of a reflective film installing portion 512 and a fixed reflective film 56 are similar to those of the first embodiment, the description thereof will not be presented here.

### Configuration of Movable Substrate

The movable substrate 52 of the variable wavelength interference filter 5A, similarly to the first embodiment, includes a movable portion 521 and a holding portion 522 that are formed through etching.

In addition, the movable substrate 52 of the variable wavelength interference filter 5A, as shown in FIGS. 7 and 9, includes notches 524 at positions corresponding to the electrode pads 546P1 and 546P2 of the fixed substrate 51. The electrode pads 546P1 and 546P2 are exposed to the face of the variable wavelength interference filter 5A that is located on the movable substrate 52 side through the notches 524.

The configurations of the movable portion 521 and the holding portion 522 are similar to those of the first embodiment, and thus the description thereof will not be presented here.

In the face of the holding portion 522 that faces the fixed substrate 51, a first movable electrode 542A and a second movable electrode 542B that face the first fixed electrode 541A and the second fixed electrode 541B are formed. Here, the first electrostatic actuator 54A is configured by the first fixed electrode 541A and the first movable electrode 542A, and the second electrostatic actuator 54B is configured by the second fixed electrode 541B and the second movable electrode 542B.

The first movable electrode 542A, as shown in FIG. 9, is configured by a plurality of (two in the second embodiment) first movable partial electrodes 544D (544D1 and 544D2) having arc shapes. The first movable partial electrode 544D configures a second partial electrode according to an embodiment of the invention in the first electrostatic actuator 54A.

In addition, similarly, the second movable electrode 542B is configured by a plurality of (two in the second embodiments) second movable partial electrodes 544E (544E1 and 544E2) having arc shapes. The second movable partial electrode 544E configures a second partial electrode according to an embodiment of the invention in the second electrostatic actuator 54B.

The two first movable partial electrodes 544D are formed so as to have the same planar shape in the filter plan view and the same thickness dimension and are arranged along the virtual circle P. In addition, the centers of gravity G_{d21} and G_{d22} of the first movable partial electrodes 544D1 and 544D2 are arranged at equal angular intervals (intervals of 180 degrees) on the virtual circle P and overlap the centers of gravity Gₐ₁₁ and G_{d12} of the first fixed partial electrodes 543D1 and 543D2.

Similarly, the second movable partial electrodes 544E are formed so as to have the same planar shape in the filter plan view and the same thickness dimension and are arranged along the virtual circle P. In addition, the centers of gravity Gₑ₂₁ and Gₑ₂₂ of the second movable partial electrodes 544E1 and 544E2 are arranged at equal angular intervals (intervals of 180 degrees) on the virtual circle P and overlap the centers of gravity Gₑ₁₁ and Gₑ₁₂ of the second fixed partial electrodes 543E1 and 543E2.

In addition, it is preferable that the first movable partial electrodes 544D and the second movable partial electrodes 544E are formed so as to have the same planar shape in the filter plan view.

Here, similarly to the first embodiment, in the filter plan view, the outer peripheral edges of the first movable partial electrode 544D and the second movable partial electrode 544E are located on the inner side of the outer peripheral edges of the first fixed partial electrode 543D and the second fixed partial electrode 543E. In addition, in the filter plan view, an area in which the first movable partial electrode 544D is arranged becomes the first partial actuator 55D of the first electrostatic actuator 54A. In addition, in the filter plan view, an area in which the second movable partial electrode 544E is arranged becomes the second partial actuator 55E of the second electrostatic actuator 54B.

In addition, the movable substrate 52 includes an inner movable connection electrode 547A having a ring shape that has the planar center point O as its center and an outer movable connection electrode 548A having a ring shape that is concentric with the inner movable connection electrode 547A.

The inner movable connection electrode 547A is formed on the inner circumference side of the virtual circle P and connects the first movable partial electrode 544D1 and the first movable partial electrode 544D2. The outer movable connection electrode 548A is formed on the outer circumference side of the virtual circle P and connects the second movable partial electrode 544E1 and the second movable partial electrode 544E2.

### Configuration of Electrostatic Actuator

FIG. 10 is a wiring diagram of the electrostatic actuators 54A and 54B of the second embodiment.

The first electrostatic actuators 54A and the second electrostatic actuator 54B, as shown in FIG. 10, are electrically connected in parallel. Accordingly, when a driving voltage is applied between the electrode pads 546P1 and 546P2, the same driving voltage is applied to the first electrostatic actuator 54A and the second electrostatic actuator 54B.

When focusing on the first electrostatic actuator 54A, the first partial actuators 55D (55D1 and 55D2) are configured by the first fixed partial electrodes 543D (543D1 and 543D2) and the first movable partial electrodes 544D (544D1 and 544D2) that face each other. In addition, the first partial actuator 55D1 and the first partial actuator 55D2, similarly to the first embodiment, are electrically connected in series.

Similarly, in the second electrostatic actuator 54B, the second partial actuators 55E (55E1 and 55E2) are configured by the second fixed partial electrodes 543E (543E1 and 543E2) and the second movable partial electrodes 544E (544E1 and 544E2) that face each other. In addition, the second partial actuator 55E1 and the second partial actuator 55E2, similarly to the first embodiment, are electrically connected in series.

Accordingly, as represented in Equations (5) to (7) described above, the electrostatic attractive forces acting on the first partial actuators 55D1 and 55D2 of the first electrostatic actuator 54A have the same value regardless of the value of the inter-partial electrode gap. Similarly in the second electrostatic actuator 54B, the electrostatic attractive forces acting on the second partial actuators 55E1 and 55E2 have the same value regardless of the value of the inter-partial electrode gap.

Accordingly, for example, in the initial gaps, even in a case where there are slight differences of levels, for example, not affecting the measurement accuracy in the values of the inter-partial electrode gaps, and a voltage is applied to the electrostatic actuators 54A and 54B, the differences in the inter-partial electrode gaps do not increase, and accordingly, the holding portion 522 can be uniformly bent.

Operation and Advantages of this Embodiment

The variable wavelength interference filter 5A according to the second embodiment includes the first electrostatic actuator 54A and the second electrostatic actuator 54B, which are electrically connected in parallel. In addition, the first electrostatic actuator 54A is configured by connecting the first partial actuators 55D1 and 55D2 in series, and the second electrostatic actuator 54B is configured by connecting the second partial actuators 55E1 and 55E2 in series. The first partial actuators 55D1 and 55D2 are arranged at an interval of 180 degrees, in other words, are arranged at positions having point symmetry with respect to the substrate center. Similarly, the second partial actuators 55E1 and 55E2 are arranged at an interval of 180 degrees, in other words, are arranged at positions having point symmetry with respect to the substrate center. In addition, the first fixed partial electrodes 543D1 and 543D2 and the first movable partial electrodes 544D1 and 544D2 that configure the first partial actuators 55D1 and 55D2 are formed so as to have the same shape in the filter plan view, the first fixed partial electrode 543D1 and the first movable partial electrode 544D1 are arranged so as to face each other, and the first fixed partial electrode 543D2 and the first movable partial electrode 544D2 are arranged so as to face each other. Furthermore, the second fixed partial electrodes 543E (543E1 and 543E2) and the second movable partial electrodes 544E (544E1 and 544E2) that configure the second partial actuators 55E1 and 55E2 are formed so as to have the same shape in the filter plan view and are arranged so as to face each other.

Accordingly, similarly to the first embodiment, when a driving voltage is applied between the electrode pads 546P1 and 546P2, the electrostatic attractive forces in the first partial actuators 55D1 and 55D2 of the first electrostatic actuator 54A have the same value, and the electrostatic attractive forces in the second partial actuators 55E1 and 55E2 of the second electrostatic actuator 54B have the same value. Accordingly, even in a case where a gap between the fixed reflective film 56 and the movable reflective film 57 is changed, the parallelism between the fixed reflective film 56 and the movable reflective film 57 can be maintained, whereby a decrease in the resolving power can be suppressed.

In addition, in the colorimetric sensor 3 that includes the above-described variable wavelength interference filter 5, light that is spectrally dispersed with high resolving power can be detected by the detection unit 31, whereby an accurate result of light amount detection can be acquired. Furthermore, the colorimetric apparatus 1 can perform a calorimetric process with high accuracy by measuring the color of the measurement target A based on the amount of light detected by the colorimetric sensor 3.

In addition, in the variable wavelength interference filter 5A according to the second embodiment, the first electrostatic actuator 54A and the second electrostatic actuator 54B are connected in parallel. In such a configuration, for example, voltages applied to the partial actuators 55D and 55E can be configured to be higher than those of a case where four partial actuators are connected in series, whereby the energy saving can be promoted.

### Third Embodiment

Next, a third embodiment of the invention will be described with reference to the drawings.

In the colorimetric apparatus 1 according to the above-described first embodiment, a configuration is employed in which the variable wavelength interference filter 5 is directly disposed in the colorimetric sensor 3 as an optical module. However, an optical module may have a complicated configuration, and accordingly, there is a case where it is difficult to directly dispose the variable wavelength interference filter 5, particularly, in a small-size optical module. In this embodiment, an optical filter device that enables the variable wavelength interference filter 5 to be easily disposed even in such an optical module will be described as below.

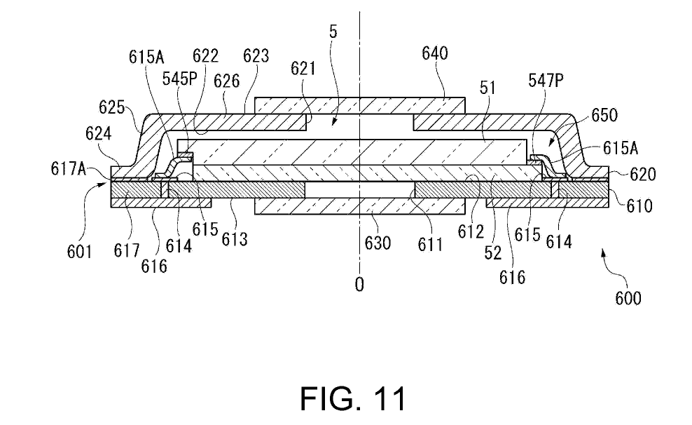

FIG. 11 is a cross-sectional view showing a schematic configuration of an optical filter device according to a third embodiment of the invention.

As shown in FIG. 11, the optical filter device 600 includes a variable wavelength interference filter 5 and a casing 601 that houses the variable wavelength interference filter 5.

The casing 601 includes a base substrate 610, a lid 620, a base-side glass substrate 630, and a lid-side glass substrate 640.

The base substrate 610, for example, is configured by a single-layer ceramic substrate. In this base substrate 610, a movable substrate 52 of the variable wavelength interference filter 5 is disposed. For the installation of the movable substrate 52 to the base substrate 610, for example, the movable substrate 52 may be arranged through an adhesive layer or the like or may be arranged by fitting it to another fixing member or the like. In addition, in the base substrate 610, in an area of the variable wavelength interference filter 5 that faces reflective films (a fixed reflective film 56 and a movable reflective film 57), a light passing hole 611 is formed as an opening. Furthermore, the base-side glass substrate 630 is bonded so as to cover the light passing hole 611. As a method of bonding the base-side glass substrate 630, for example, a glass frit bonding method in glass frits acquired by melting a glass raw material at high temperature and rapidly cooling the glass as glass fragments frit, a method of bonding using an epoxy resin or the like can be used.

In the base inner face 612 of the base substrate 610 that faces the lid 620, inner terminal portions 615 that are connected to the electrode pads 545P and 547P of the variable wavelength interference filter 5 are disposed. For the connections between the electrode pads 545P and 547P and the inner terminal portions 615, for example, FPC (Flexible Printed Circuits) 615A can be used, and, for example, bonding is made using an Ag paste, an ACF (Anisotropic Conductive Film), an ACP (Anisotropic Conductive Paste), or the like. In addition, in a case where an inner space 650 is maintained in a vacuum state, it is preferable to use the AG paste for which the amount of degassing (discharge of gas) is small. Furthermore, the connection is not limited to the connection using the FPC 615A, and, for example, a wiring connection using wire bonding or the like may be performed.

In addition, in the base substrate 610, through holes 614 are formed in correspondence with the positions at which the inner terminal portions 615 are disposed, and each inner terminal portion 615 is connected an outer terminal portion 616 disposed on the base outer face 613 that is located on a side opposite to the base inner face 612 of the base substrate 610 through a conductive member filled in the through hole 614.

Furthermore, in the outer peripheral portion of the base substrate 610, a base bonding portion 617 that is bonded to the lid 620 is disposed.

The lid 620, as shown in FIG. 11, includes: a lid bonding portion 624 that is bonded to the base bonding portion 617 of the base substrate 610; a side wall portion 625 that is formed to be continuous from the lid bonding portion 624 and rises in a direction departing away from the base substrate 610; and a top face portion 626 that is formed to be continuous from the side wall portion 625 and covers the fixed substrate 51 side of the variable wavelength interference filter 5. For example, the lid 620 may be formed from alloy such as kovar or metal.

This lid 620 is tightly bonded to the base substrate 610 by bonding the lid bonding portion 624 and the base bonding portion 617 of the base substrate 610 together.

As the bonding method, for example, laser welding, soldering using silver solder or the like, sealing using an eutectic alloy layer, welding using low-melting point glass, glass attachment, glass frit bonding, bonding using an epoxy resin, or the like may be used. The bonding method may be appropriately selected based on the materials of the base substrate 610 and the lid 620, the bonding environments, and the like.

The top face portion 626 of the lid 620 is disposed to be parallel to the base substrate 610. In this top face portion 626, light passing holes 621 are formed in areas facing the reflective films 56 and 57 of the variable wavelength interference filter 5 as openings. In addition, the lid-side glass substrate 640 is bonded thereto so as to cover the light passing holes 621. As the method of bonding the lid-side glass substrate 640, similarly to the bonding of the base-side glass substrate 630, for example, glass frit bonding, adhesive bonding using an epoxy resin, or the like can be used.

### Operation and Advantages of Third Embodiment

In the optical filter device 600 according to this embodiment, since the variable wavelength interference filter 5 is protected by the casing 601, a change in the characteristics of the variable wavelength interference filter 5 that is caused by a foreign material, gas contained in the atmosphere, or the like can be prevented, and a damage in the variable wavelength interference filter 5 that is caused by an external factor can be prevented. In addition, since the penetration of charged particles can be prevented, charging of the fixed electrode 541 or the movable electrode 542 can be prevented. Therefore, the generation of a Coulomb force according to charging can be suppressed, whereby the parallelism between the reflective films 56 and 57 can be maintained more reliably.

In addition, in a case where the variable wavelength interference filter 5, for example, manufactured in a factory, is delivered to an assembly line used for assembling an optical module or an electronic apparatus or the like, the variable wavelength interference filter 5 protected by the optical filter device 600 can be safely delivered.

Furthermore, in the optical filter device 600, since the outer terminal portion 616 that is exposed at the outer peripheral face of the casing 601 is disposed, it is possible to easily perform wiring at the time of building the optical filter device 600 into an optical module or an electronic apparatus.

### Other Embodiments

The invention is not limited to the above-described embodiments, and modifications, improvements, or the like thereof within the scope in which the advantages according to an embodiment of the invention can be achieved belong to the invention.

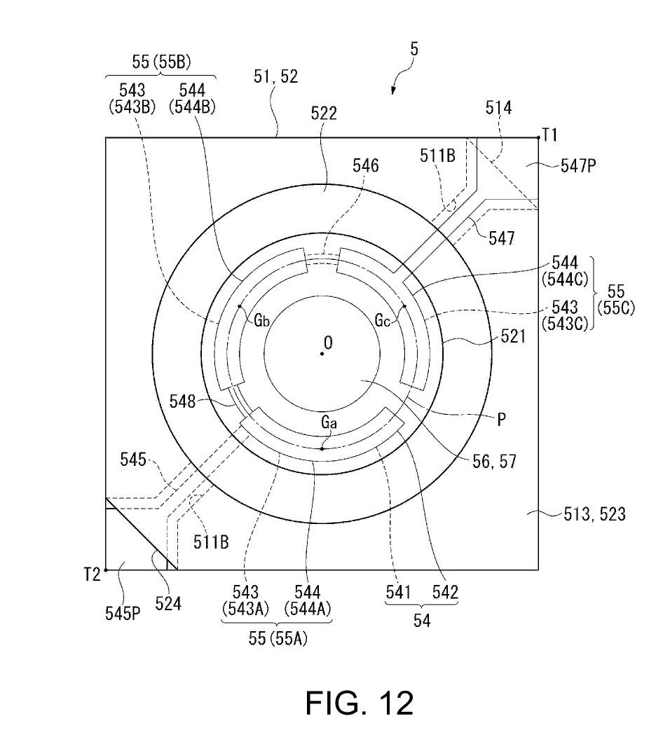

For example, in the first and second embodiments, although an example has been shown in which the outer peripheral edge of the movable partial electrode 544 is arranged on the inner side of outer peripheral edge of the fixed partial electrode 543 in the filter plan view, in other words, an example has been shown in which the movable partial electrode 544 is formed so as to have a size smaller than the fixed partial electrode 543, the invention is not limited thereto. For example, as shown in FIG. 12, a configuration may be employed in which the fixed partial electrode 543 and the movable partial electrode 544 are formed in the same shape, and the outer peripheries thereof completely coincide with each other in the filter plan view.

In addition, according to an embodiment of the invention, the shapes of the fixed electrode 541 and the movable electrode 542 are not particularly limited, as long as the areas of the partial actuators 55 in the filter plan view are the same, and a condition is satisfied in which the centers of gravity of the partial actuators 55 are arranged at equal angular intervals on the circumference of the virtual circle P.

For example, a configuration may be employed in which the length dimension L1 of the fixed partial electrode 543 is larger than the length dimension L2 of the movable partial electrode 544, and the width dimension D1 of the fixed partial electrode 543 is smaller than the width dimension D2 of the movable partial electrode 544. In addition, a configuration may be employed in which the fixed partial electrodes 543 are formed in different shapes, and the movable partial electrodes 544 are formed in different shapes. Even in such a case, when the above-described condition is satisfied, the electrostatic attractive forces F acting on the partial actuators can be made uniform, whereby the movable portion 521 can be suppressed from being tilted.

In the first and second embodiments described above, although an example has been illustrated in which the movable area of the second substrate according to an embodiment of the invention is configured by the movable portion 521 and the holding portion 522, the invention is not limited thereto. For example, a plate-shaped member having a uniform thickness in which the holding portion 522 is not arranged may be used as the second substrate. In such a case, it is preferable that, in the plan view as viewed in the substrate thickness direction of the second substrate, the electrostatic actuator is disposed such that the second substrate is bent to the first substrate side with the center point of the movable reflective film 58 being used as the center. In other words, it is preferable that the center of gravity of the movable area is set as the center point of the movable reflective film 58.

In addition, in the first and second embodiments described above, although the holding portion 522 having the diaphragm shape is illustrated as an example, for example, a configuration or the like may be employed in which a plurality of holding portions each having a beam structure that are arranged at equal angular intervals with respect to the center of the movable portion is disposed.

In such a case, by employing a configuration in which the holding portions each having the beam shape are arranged at equal angular intervals, the stress balance can be made uniform when the holding portions are bent, whereby the movable portion can be suppressed from the being tilted. In such a case, the electrostatic actuator may have a configuration in which the partial actuators are arranged in correspondence with the positions of the holding portions each having the beam shape.

In the first embodiment, although a configuration example in which three partial actuators 55 are disposed has been illustrated, a configuration may be employed in which more partial actuators 55 are connected in series.

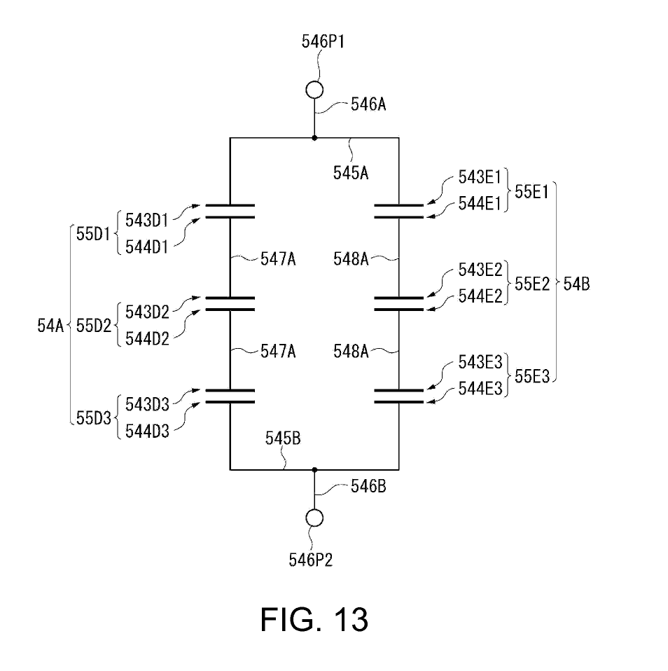

Similarly, in the second embodiment, although an example has been illustrated in which each of the first electrostatic actuator 54A and the second electrostatic actuator 54B includes two partial actuators 55, for example, as shown in FIG. 13, a configuration may be employed in which more partial actuators 55 are included. In the example shown in FIG. 13, the first electrostatic actuator 54A includes: the first partial actuator 55D1 that is configured by the first fixed partial electrode 543D1 and the first movable partial electrode 544D1; the first partial actuator 55D2 that is configured by the first fixed partial electrode 543D2 and the first movable partial electrode 544D2; and the first partial actuator 55D3 that is configured by the first fixed partial electrode 543D3 and the first movable partial electrode 544D3. In addition, the second electrostatic actuator 54B includes: the second partial actuator 55E1 that is configured by the second fixed partial electrode 543E1 and the second movable partial electrode 544E1; the second partial actuator 55E2 that is configured by the second fixed partial electrode 543E2 and the second movable partial electrode 544E2; and the second partial actuator 55E3 that is configured by the second fixed partial electrode 543E3 and the second movable partial electrode 544E3.

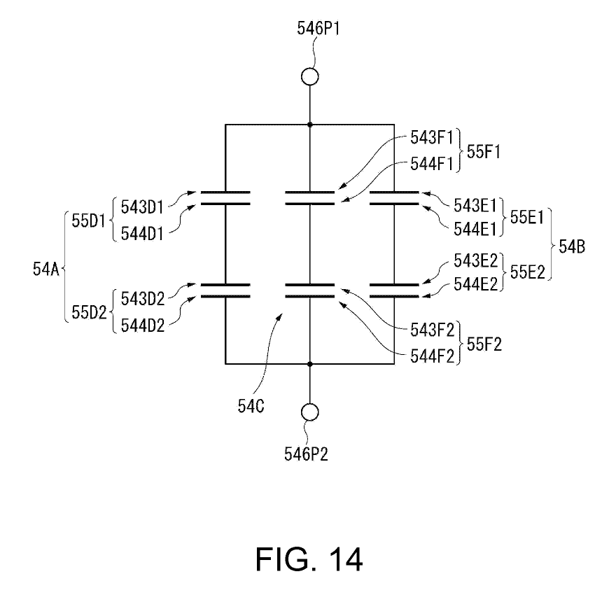

In addition, in the second embodiment, although an example has been illustrated in which the first electrostatic actuator 54A and the second electrostatic actuator 54B are connected in parallel, more electrostatic actuators may be connected in parallel. For example, as shown in FIG. 14, a first electrostatic actuator 54A, a second electrostatic actuator 54B, and a third electrostatic actuator 54C may be connected in parallel. In the example illustrated in FIG. 14, the third electrostatic actuator 54C includes: a third partial actuator 55F1 that is configured by a third fixed partial electrode 543F1 and the third movable partial electrode 544F1 and a third partial actuator 55F2 that is configured by a third fixed partial electrode 543F2 and the third movable partial electrode 544F2.

In the second embodiment, although a configuration has been illustrated in which the first partial actuators 55D1 and 55D2 of the first electrostatic actuator 54A and the second partial actuators 55E1 and 55E2 of the second electrostatic actuator 54B have the same shape, the invention is not limited thereto. For example, the first partial actuator 55D1 (55D2) and the second partial actuator 55E1 (55E2) may be formed in different shapes and different areas in the filter plan view.

In the first and second embodiments described above, although an example has been illustrated as the variable wavelength interference filters 5 and 5A in which the movable portion 521 is disposed in the movable substrate 52, which is the second substrate, and the movable portion 521 of the movable substrate 52 is displaced toward the fixed substrate 51 side, the invention is not limited thereto. For example, a configuration or the like may be employed in which a movable portion is disposed also in the fixed substrate 51, and the movable portion can be displaced to the movable substrate 52 side.

In the first and second embodiments described above, in order to connect the first movable partial electrodes 544D, although the outer movable connection electrode 548A having a ring shape is used so as to connect the second movable partial electrodes 544E by using the inner movable connection electrode 547A having a ring shape, the invention is not limited thereto. In other words, in a configuration in which the first movable partial electrodes 544D are connected together, and the second movable partial electrodes 544E are connected together, connection electrodes each having any arbitrary shape may be formed. However, in a case where the connection electrodes are formed on the holding portion 522, it is necessary to maintain the movable portions 521 to be parallel to each other by making uniform the bending of the holding portion 522. Accordingly, it is preferable that the connection electrodes are formed in shapes having point symmetry with respect to the substrate center (the center of the movable portion 521), and similarly to the second embodiment, by forming the connection electrodes in a ring shape concentric to the virtual circle P, the stress balance of the holding portion 522 can be uniformly maintained.

In the first and second embodiments described above, although an example has been illustrated in which the movable electrode 542 is disposed in the movable face 521A of the movable portion 521, the invention is not limited thereto. For example, a configuration may be employed in which the movable electrode 542 is disposed in a face of the holding portion 522 that faces the fixed substrate 51 of the holding portion 522. However, in a case where the movable electrode 542 is formed on the holding portion 522, the holding portion 522 may be bent due to the influence of the film stress of the movable electrode 542. In such a case, by disposing an anti-bending film used for offsetting the film stress of the movable electrode 542 on a side opposite to the face of the holding portion 522 in which the movable electrode 542 is disposed or by configuring the movable electrode 542 by using a plurality of electrode layers (an electrode layer having stretching stress and an electrode layer having compressive stress) having different acting directions of the film stress, the influence of the film may be decreased.

In addition, as an electronic apparatus according to an embodiment of the invention, although the colorimetric apparatus 1 according to the first embodiment has been described as an example, a variable wavelength interference filter, an optical filter device, an optical module, and an electronic apparatus other than the colorimetric apparatus 1 in various fields can be used.

For example, an electronic apparatus according to an embodiment of the invention may be used as an optic-based system that is used for detecting the presence of a specific material. As examples of a such a system, there are gas detecting apparatuses such as a vehicle-mounting gas leakage detector that detects specific gas with high sensitivity by employing an optical measurement type, for example, using as variable wavelength interference filter according to an embodiment of the invention and an optoacoustic rare gas detector used for testing expired gas.

An example of the gas detecting apparatus will be described with reference to the drawings.

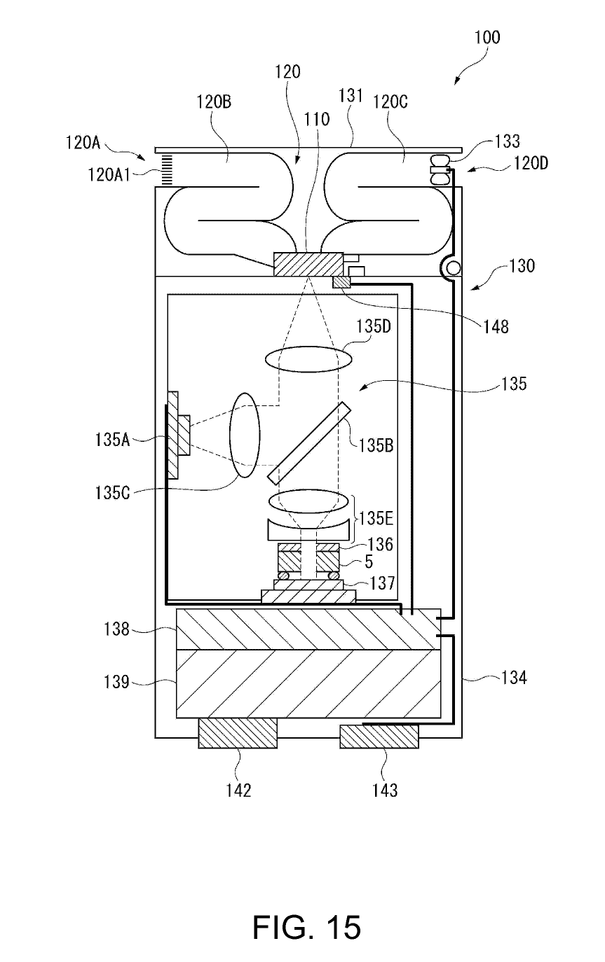

FIG. 15 is a schematic diagram showing an example of a gas detecting apparatus that includes a variable wavelength interference filter.

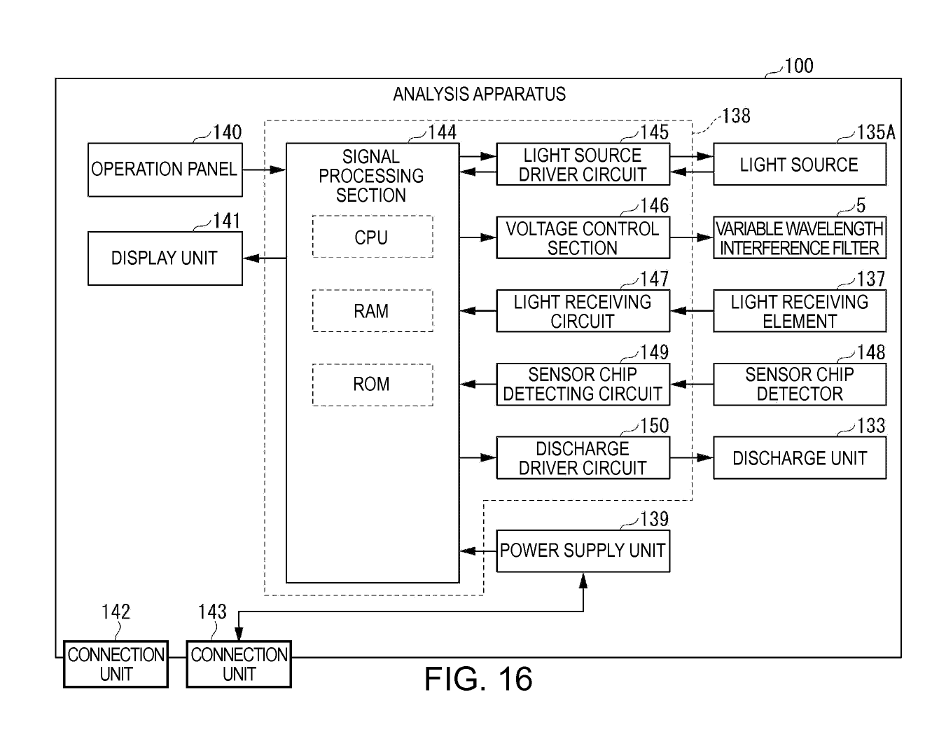

FIG. 16 is a block diagram showing the configuration of a control system of the gas detecting apparatus shown in FIG. 15.

This gas detecting apparatus 100, as shown in FIG. 15, is configured so as to include: a sensor chip 110; a flow path 120 that includes a suction opening 120A, a suction flow path 120B, a discharge flow path 120C, and a discharge opening 120D; and a main body unit 130.

The main body unit 130 is configured by: a detection device that includes a sensor unit cover 131 having an opening through which the flow path 120 can be detachably attached, a discharge unit 133, a casing 134, an optical unit 135; a filter 136, a variable wavelength interference filter 5, a light receiving element 137 (detection unit), and the like; a control unit 138 that processes a detection signal and controls the detection unit; a power supply unit 139 that supplies power; and the like. In addition, the optical unit 135 is configured by: a light source 135A that emits light; a beam splitter 135B that reflects light incident from the light source 135A to the sensor chip 110 side so as to allow the light incident from the sensor chip side to be transmitted to the light receiving element 137 side; and lenses 135C, 135D, and 135E. Here, instead of the variable wavelength interference filter 5, the variable wavelength interference filter 5A or the optical filter device 600 may be arranged.

In addition, as shown in FIG. 16, on the surface of the gas detecting apparatus 100, an operation panel 140, a display unit 141, a connection unit 142 that is used for an interface with an external member, and a power supply unit 139 are disposed. In a case where the power supply unit 139 is a secondary battery, a connection unit 143 used for charging may be included.

Furthermore, the control unit 138 of the gas detecting apparatus 100, as shown in FIG. 16, includes: a signal processing section 144 that is configured by a CPU or the like; a light source driver circuit 145 that is used for controlling the light source 135A; a voltage control section 146 that is used for controlling the variable wavelength interference filter 5; a light receiving circuit 147 that receives a signal from the light receiving element 137; a sensor chip detecting circuit 149 that receives a signal transmitted from a sensor chip detector 148 that reads out a code of the sensor chip 110 and detects the presence of the sensor chip 110; a discharge driver circuit 150 that controls the discharge unit 133, and the like.

Next, the operation of the above-described gas detecting apparatus 100 will be described as below.

Inside the sensor unit cover 131 located in the upper portion of the main body unit 130, the sensor chip detector 148 is disposed, and the presence of a sensor chip 110 is detected by the sensor chip detector 148. When detecting a detection signal transmitted from the sensor chip detector 148, the signal processing section 144 determines a state in which the sensor chip 110 is installed and outputs a display signal that is used for displaying an indication that a detection operation can be performed on the display unit 141.

For example, when the operation panel 140 is operated by a user, and an instruction signal indicating the start of a detection process is output from the operation panel 140 to the signal processing section 144, first, the signal processing section 144 operates the light source 135A by outputting a light source operating signal to the light source driver circuit 145. When the light source 135A is driven, a stable laser beam of linear polarized light having a single wavelength is emitted from the light source 135A. In addition, a temperature sensor or a light amount sensor is built in the light source 135A, and the information thereof is output to the signal processing section 144. Then, when it is determined that the light source 135A is in a stable operation based on the temperature or the light amount that is input from the light source 135A, the signal processing section 144 operates the discharge unit 133 by controlling the discharge driver circuit 150. Accordingly, a gaseous sample containing a target substance (gaseous molecule) to be detected is induced from the suction opening 120A to the suction flow path 120B, the inside of the sensor chip 110, the discharge flow path 120C, and the discharge opening 120D. In addition, a dust filter 120A1 is disposed in the suction opening 120A, and accordingly, relatively large dust particles, a part of moisture vapor, and the like are removed.

In addition, a plurality of a metal nano structure bodies is built in the sensor chip 110, and the sensor chip 110 is a sensor that utilizes a local surface plasmon resonance. In such a sensor chip 110, a reinforced electric field is formed between the metal nano structure bodies in accordance with the laser beam. When a gaseous molecule enters the inside of the reinforced electric field, Raman scattering light and Rayleigh scattering light that include information of molecular vibration are generated.

The Rayleigh scattering light and the Raman scattering light pass through the optical unit 135 so as to be incident to the filter 136, the Rayleigh scattering light is separated by the filter 136, and the Raman scattering light is incident to the variable wavelength interference filter 5. Then, the signal processing section 144 adjusts a voltage applied to the variable wavelength interference filter 5 by controlling the voltage control section 146 and spectrally disperses the Raman scattering light corresponding to the gaseous molecule as a detection target by using the variable wavelength interference filter 5. Thereafter, when the spectrally dispersed light is received by the light receiving element 137, a light reception signal corresponding to the amount of received light is output to the signal processing section 144 through the light receiving circuit 147.

The signal processing section 144 compares the spectrum data of the Raman scattering light corresponding to the gaseous molecule as the detection target, which has been acquired as above, and data stored in the ROM, determines whether or not there is a gaseous molecule as the target, and specifies the substance. In addition, the signal processing section 144 displays information of the result on the display unit 141 or outputs the information of the result from the connection unit 142 to the outside thereof.

Although the gas detecting apparatus 100 has been described as an example with reference to FIGS. 15 and 16, which spectrally disperses the Raman scattering light through the variable wavelength interference filter 5 and detects gas based on the spectrally dispersed Raman scattering light, a gas detecting apparatus that specifies the kind of gas by detecting the absorbance, which is unique to each kind of gas, may be used. In such a case, a gas sensor that allows gas to flow inside the sensor and detects light absorbed through the gas out of the incident light is used as an optical module according to an embodiment of the invention. In addition, a gas detecting apparatus that analyzes and determines the gas flowing into the inside of the sensor by using the gas sensor is used as an electronic apparatus according to an embodiment of the invention. Also in such a configuration, the components of the gas can be detected by using the variable wavelength interference filter.

In addition, the system used for detecting the presence of a specific substance is not limited to the detection of gas described above, and examples thereof include substance component analyzing apparatuses such as a noninvasive measurement apparatus of sugar through the spectroscopy of near infrared light and a noninvasive measurement apparatus of information of a food, a living organism, a mineral, or the like.

Hereinafter, a food analyzing apparatus as an example of the substance component analyzing apparatus will be described.

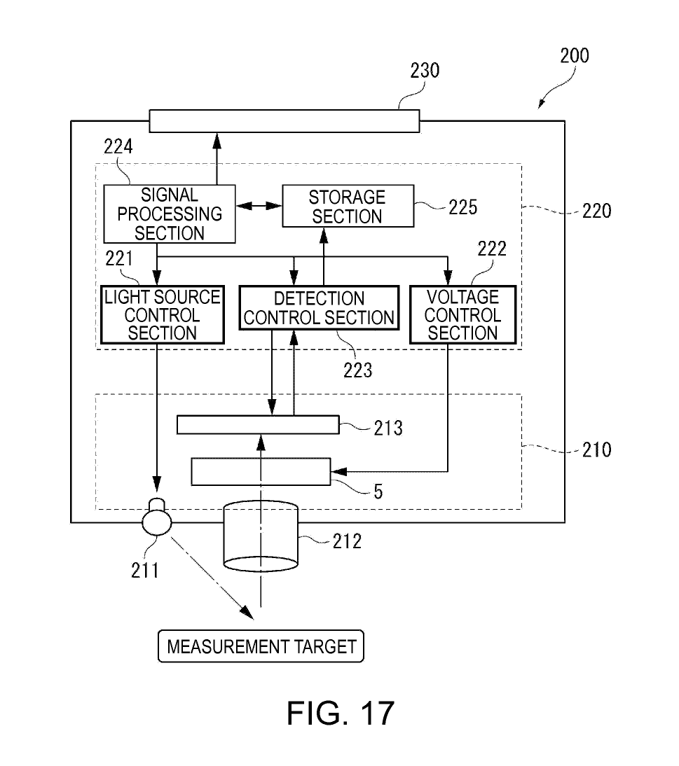

FIG. 17 is a diagram showing a schematic configuration of a food analyzing apparatus as an example of an electronic apparatus using the variable wavelength interference filter 5.

This food analyzing apparatus 200, as shown in FIG. 17, includes a detector 210 (optical module), a control unit 220, and a display unit 230. The detector 210 includes: alight source 211 that emits light; an imaging lens 212 to which light from a measurement target is introduced; the variable wavelength interference filter 5 that spectrally disperses the light introduced from the imaging lens 212; and an imaging unit 213 (detection unit) that detects the spectrally dispersed light. Here, instead of the variable wavelength interference filter 5, the variable wavelength interference filter 5A or the optical filter device 600 may be arranged.

In addition, the control unit 220 includes: a light source control section 221 that controls turning on/off of the light source 211 and the brightness at the time of turning-on; a voltage control section 222 that controls the variable wavelength interference filter 5; a detection control section 223 that acquires an image that is spectrally dispersed by the imaging unit 213 by controlling the imaging unit 213; a signal processing section 224; and a storage section 225.

When the system is driven, in the food analyzing apparatus 200, the light source 211 is controlled by the light source control section 221, and light is emitted to a measurement target from the light source 211. The light reflected by the measurement target passes through the imaging lens 212 and is incident to the variable wavelength interference filter 5. A voltage that can spectrally disperse a desired wavelength is applied to the variable wavelength interference filter 5 under the control of the voltage control section 222, and the spectrally-dispersed light is imaged by the imaging unit 213 that is, for example, configured by a CCD camera or the like. In addition, the imaged light is stored in the storage section 225 as a spectrally dispersed image. Furthermore, the signal processing section 224 changes a voltage value to be applied to the variable wavelength interference filter 5 by controlling the voltage control section 222, thereby acquiring a spectrally dispersed image for each wavelength.

Then, the signal processing section 224 performs a calculation process of data of pixels of each image stored in the storage section 225 and acquires the spectrum of the pixels. In addition, in the storage section 225, for example, information of the components of a food for the spectrum is stored, and the signal processing section 224 analyzes the data of the acquired spectrum using the information of foods stored in the storage section 225 as a base and acquires the components of a food included as a detection target and the contents thereof. Furthermore, the calorie and the degree of freshness, and the like of the food can be calculated based on the components of the food and the contents thereof that have been acquired. In addition, by analyzing the spectrum distribution in the image, the extraction of a part of foods of which the degree of freshness decreases out of foods as detection targets or the like can be performed, and the detection of a foreign material or the like that is included in the food can be performed.

In addition, the signal processing section 224 performs a process of displaying the components, the contents, the calories, the degrees of freshness, and the like of foods as test targets, which have been acquired as described above, on the display unit 230.

In FIG. 17, although an example of the food analyzing apparatus 200 is illustrated, by employing an approximately same configuration, it can be used as a noninvasive measurement apparatus of the other information as described above. For example, it can be used as a living organism analyzing apparatus that performs analysis of the components of a living organism such as measurement, analysis, or the like of the components of a body fluid such as blood. As such a living organism analyzing apparatus, by configuring an apparatus detecting ethyl alcohol as an apparatus that measures the components of a body fluid such as blood, it can be used as an apparatus preventing driving under the influence of alcohol that detects the influenced state of a driver. In addition, it can be used as an electronic endoscopic system that includes the living organism analyzing apparatus.

In addition, it can be used as a mineral analyzing apparatus that analyzes the components of a mineral.

Furthermore, the variable wavelength interference filter, the optical module, and the electronic apparatus according to embodiments of the invention can be applied to apparatuses as below.

For example, by changing the intensity of light of each wavelength by time, data can be transmitted through light of each wavelength. In such a case, the data transmitted through the light of a specific wavelength can be extracted by spectrally dispersing the light of the specific wavelength by using the variable wavelength interference filter disposed in the optical module and receiving the light by using a light receiving unit, and, by using an electronic apparatus that includes such an optical module for data extraction, optical communication can be performed by processing the data of light of each wavelength.

In addition, as an electronic apparatus, by spectrally dispersing light by using the variable wavelength interference filter according to an embodiment of the invention, it can be applied to a spectral camera that images a spectral image, a spectral analyzer, or the like. As an example of the spectral camera, there is an infrared camera in which the variable wavelength interference filter is built.

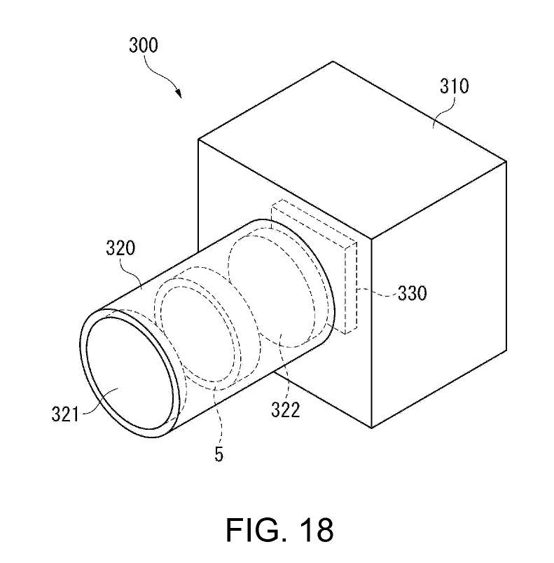

FIG. 18 is a schematic diagram showing a schematic configuration of a spectral camera. The spectral camera 300, as shown in FIG. 18, includes a camera main body 310, an imaging lens unit 320, and an imaging unit 330 (detection unit).

The camera main body 310 is a part that is gripped and operated by a user.

The imaging lens unit 320 is disposed in the camera main body 310 and guides incident image light to the imaging unit 330. In addition, this imaging lens unit 320, as shown in FIG. 18, is configured to include an objective lens 321, an imaging lens 322, and the variable wavelength interference filter 5 disposed therebetween. Here, instead of the variable wavelength interference filter 5, the variable wavelength interference filter 5A or the optical filter device 600 may be disposed.

The imaging unit 330 is configured by a light receiving element and images the image light guided by the imaging lens unit 320.

In such a spectral camera 300, by allowing light of a wavelength as an imaging target to be transmitted through the variable wavelength interference filter 5, a spectral image of light of a desired wavelength can be imaged.

In addition, the variable wavelength interference filter according to an embodiment of the invention may be used as a band pass filter, and, for example, it can be used in an optical laser apparatus that spectrally disperses only light of a narrow band, which has a predetermined wavelength as its center, to be transmitted out of light of a predetermined wavelength band that is emitted by the light emitting element.

Furthermore, the variable wavelength interference filter according to an embodiment of the invention may be used as a living organism authorizing apparatus, and, for example, it can be applied to an apparatus for authorizing blood vessels, a fingerprint, a retina, or an iris, for example, by using light of a near-infrared region or the visible region.

In addition, the optical module and the electronic apparatus can be used as a density detecting apparatus. In such a case, by using the variable wavelength interference filter, the density of a body being tested out of samples is measured by spectrally dispersing and analyzing infrared energy (infrared light) emitted from a substance.

As described above, the variable wavelength interference filter, the optical module, and the electronic apparatus according to embodiments of the invention can be applied to any apparatus that spectrally disperses predetermined light out of incident light. In addition, since the variable wavelength interference filter according to an embodiment of the invention, as described above, can spectrally disperse a plurality of wavelengths by using one device, measurement of the spectrums of a plurality of wavelengths and detection of a plurality of components can be performed with high accuracy. Accordingly, compared to a general apparatus that extracts a desired wavelength by using a plurality of devices, the optical module or the electronic apparatus can be miniaturized further, and, for example, can be appropriately used as a portable optical device or a vehicle-mounting optical device.

Furthermore, a specific structure used when an embodiment of the invention is performed can be appropriately changed to another structure in the scope for achieving the advantages according to an embodiment of the invention.

The entire disclosures of Japanese Patent Application Nos. 2010-284574 filed Dec. 21, 2010 and 2011-225892 filed Oct. 13, 2011 are expressly incorporated by reference herein.

What is claimed is:

1. A variable wavelength interference filter comprising:
a first substrate;
a second substrate facing the first substrate;
a first reflective film that is disposed on the first substrate;
a movable area that is disposed in the second substrate and can advance or retreat with respect to the first substrate;
a second reflective film that is disposed on the movable area of the second substrate and faces the first reflective film across a gap; and
an electrostatic actuator that includes a first electrode disposed on the first substrate and a second electrode disposed on the second substrate and facing the first electrode and moves the movable area with respect to the first substrate in accordance with voltage application,
wherein the first electrode includes a plurality of first partial electrodes,
wherein the second electrode includes a plurality of second partial electrodes,
wherein each one of the second partial electrodes is disposed in correspondence with any one of the plurality of first partial electrodes,
wherein, in a plan view of the first substrate and the second substrate, at least a part of each second partial electrode overlaps the first partial electrode corresponding thereto,
wherein the electrostatic actuator includes a plurality of partial actuators configured by an area where corresponding first and second partial electrodes overlap each other in the plan view,
wherein partial electrodes for voltage application are configured by any two of the first partial electrodes and the second partial electrodes,
wherein each of the plurality of partial actuators has an equal area in the plan view, and centers of gravity of the partial actuators are arranged at equal angular intervals on a virtual circle that has a center of gravity of the movable area as its center, and
wherein, in the electrostatic actuator, the plurality of partial actuators are electrically connected to each other in series between the partial electrodes for voltage application.

2. The variable wavelength interference filter according to claim 1, wherein, in the plan view, an outer peripheral edge of one of the first partial electrode and the second partial electrode that configure the partial actuator is located on an inner side of an outer peripheral edge of the other.

3. The variable wavelength interference filter according to claim 1,
wherein each of the plurality of first partial electrodes has the same shape in the plan view, and
wherein each of the plurality of second partial electrodes has the same shape in the plan view.

4. The variable wavelength interference filter according to claim 1,
wherein the two partial electrodes for voltage application are arranged so as to be adjacent to each other on the virtual circle, and
wherein, in the electrostatic actuator, the partial actuators arranged along a circumferential direction of the virtual circle are electrically connected in series sequentially between the two partial electrodes for voltage application.

5. The variable wavelength interference filter according to claim 1, wherein a plurality of the electrostatic actuators is disposed, and the electrostatic actuators are electrically connected to each other in parallel.

6. An optical filter device comprising:
a variable wavelength interference filter that includes:
a first substrate;
a second substrate facing the first substrate;
a first reflective film that is disposed on the first substrate;
a movable area that is disposed in the second substrate and can advance or retreat with respect to the first substrate;
a second reflective film that is disposed on the movable area of the second substrate and faces the first reflective film across a gap; and
an electrostatic actuator that includes a first electrode disposed on the first substrate and a second electrode disposed on the second substrate and facing the first electrode and moves the movable area with respect to the first substrate in accordance with voltage application; and
a casing that houses the variable wavelength interference filter,
wherein the first electrode includes a plurality of first partial electrodes,
wherein the second electrode includes a plurality of second partial electrodes,
wherein each one of the second partial electrodes is disposed in correspondence with any one of the plurality of first partial electrodes,
wherein, in a plan view of the first substrate and the second substrate, at least a part of each second partial electrode overlaps the first partial electrode corresponding thereto,
wherein the electrostatic actuator includes a plurality of partial actuators configured by an area where corresponding first and second partial electrodes overlap each other in the plan view,
wherein partial electrodes for voltage application are configured by any two of the first partial electrodes and the second partial electrodes,
wherein each of the plurality of partial actuators has an equal area in the plan view, and centers of gravity of the partial actuators are arranged at equal angular intervals on a virtual circle that has a center of gravity of the movable area as its center, and
wherein, in the electrostatic actuator, the plurality of partial actuators are electrically connected to each other in series between the partial electrodes for voltage application.

7. An optical module comprising:
a variable wavelength interference filter that includes a first substrate;
a second substrate facing the first substrate;
a first reflective film that is disposed on the first substrate;
a movable area that is disposed in the second substrate and can advance or retreat with respect to the first substrate;
a second reflective film that is disposed on the movable area of the second substrate and faces the first reflective film across a gap;
an electrostatic actuator that includes a first electrode disposed on the first substrate and a second electrode disposed on the second substrate and facing the first electrode and moves the movable area with respect to the first substrate in accordance with voltage application; and
a detection unit that detects light extracted by the variable wavelength interference filter,
wherein the first electrode includes a plurality of first partial electrodes,
wherein the second electrode includes a plurality of second partial electrodes,
wherein each one of the second partial electrodes is disposed in correspondence with any one of the plurality of first partial electrodes,
wherein, in a plan view of the first substrate and the second substrate, at least a part of each second partial electrode overlaps the first partial electrode corresponding thereto,
wherein the electrostatic actuator includes a plurality of partial actuators configured by an area where corresponding first and second partial electrodes overlap each other in the plan view,
wherein partial electrodes for voltage application are configured by any two of the first partial electrodes and the second partial electrodes,
wherein each of the plurality of partial actuators has an equal area in the plan view, and centers of gravity of the partial actuators are arranged at equal angular intervals on a virtual circle that has a center of gravity of the movable area as its center, and
wherein, in the electrostatic actuator, the plurality of partial actuators are electrically connected to each other in series between the partial electrodes for voltage application.

8. An electronic apparatus comprising:
a first substrate;
a second substrate facing the first substrate;
a first reflective film that is disposed on the first substrate;
a movable area that is disposed in the second substrate and can advance or retreat with respect to the first substrate;
a second reflective film that is disposed on the movable area of the second substrate and faces the first reflective film across a gap; and
an electrostatic actuator that includes a first electrode disposed on the first substrate and a second electrode disposed in the second substrate and facing the first electrode and moves the movable area with respect to the first substrate in accordance with voltage application,
wherein the first electrode includes a plurality of first partial electrodes,
wherein the second electrode includes a plurality of second partial electrodes,
wherein each one of the second partial electrodes is disposed in correspondence with any one of the plurality of first partial electrodes,
wherein, in a plan view of the first substrate and the second substrate, at least a part of each second partial electrode overlaps the first partial electrode corresponding thereto,
wherein the electrostatic actuator includes a plurality of partial actuators configured by an area where corresponding first and second partial electrodes overlap each other in the plan view,
wherein partial electrodes for voltage application are configured by any two of the first partial electrodes and the second partial electrodes,
wherein each of the plurality of partial actuators has an equal area in the plan view, and centers of gravity of the partial actuators are arranged at equal angular intervals on a virtual circle that has a center of gravity of the movable area as its center, and
wherein, in the electrostatic actuator, the plurality of partial actuators are electrically connected to each other in series between the partial electrodes for voltage application.

9. A variable wavelength interference filter comprising:
a movable area that is disposed in the second substrate and can advance or retreat with respect to the first substrate,
an electrostatic actuator that includes a first electrode on the first substrate and a second electrode on a second substrate and facing the first electrode and moves the movable area in accordance with voltage application,
wherein the first electrode includes a plurality of first partial electrodes,
wherein the second electrode includes a plurality of second partial electrodes,
wherein each one of the second partial electrodes is disposed in correspondence with any one of the plurality of first partial electrodes,
wherein, in a plan view of the first substrate and the second substrate, at least a part of each second partial electrode overlaps the first partial electrode corresponding thereto,
wherein the electrostatic actuator includes a plurality of partial actuators configured by an area where corresponding first and second partial electrodes overlap each other in the plan view,
wherein partial electrodes for voltage application are configured by any two of the first partial electrodes and the second partial electrodes,
wherein each of the plurality of partial actuators has an equal area in the plan view, and centers of gravity of the partial actuators are arranged at equal angular intervals on a virtual circle that has a center of gravity of the movable area as its center, and
wherein, in the electrostatic actuator, the plurality of partial actuators are electrically connected to each other in series between the partial electrodes for voltage application.
